(19) United States
(12) Patent Application Publication
(10) Pub. No.: US 2012/0197788 A1
(43) Pub. Date: Aug. 2, 2012

(54) TRANSACTION PROCESSING ENGINE FOR BILL PAYMENT TRANSACTIONS AND THE LIKE

(75) Inventors: Hemal Sanghvi, St. Charles, MO (US); Sridhar Ramalingam, Wildwood, MO (US); Rich Ampleman, Florissant, MO (US); Robert Hoffman, Manchester, MO (US); Pauline Ow, Chesterfield, MO (US); Stephen Klaus, St. Louis, MO (US); Gidget A. Hall, Chesterfield, MO (US)

(73) Assignee: MasterCard International Incorporated, Purchase, NY (US)

(21) Appl. No.: 13/358,276

(22) Filed: Jan. 25, 2012

Related U.S. Application Data
(60) Provisional application No. 61/438,106, filed on Jan. 31, 2011.

(51) Int. Cl. G06Q 20/14

(52) U.S. Cl. 705/40

(57) ABSTRACT

A payment processing network operator obtains, from customer service providers, a first plurality of messages specifying a plurality of bill payments to a plurality of biller entities. Said first plurality of messages specifies, for each of the bill payments, an amount and an intended one of the biller entities to be paid. Based on the first plurality of messages, the operator of the payment processing network dispatches, to the plurality of biller entities, a second plurality of messages to initiate the plurality of bill payments. The operator of the payment processing network obtains data that specifies when at least some of the first plurality of messages are to be obtained and/or when at least some of the second plurality of messages are to be dispatched. Obtaining the first plurality of messages and/or scheduling dispatching the second plurality of messages are carried out in accordance with the data.

### CROSS-REFERENCE TO RELATED APPLICATIONS

This patent application claims the benefit of U.S. Provisional Patent Application Ser. No. 61/438,106 filed on Jan. 31, 2011, and entitled “Transaction Processing Engine for Consumer Bill Payment Transactions and the Like.” The disclosure of the aforementioned Provisional Patent Application Ser. No. 61/438,106, including all three appendices thereof, is expressly incorporated herein by reference in its entirety for all purposes.

### FIELD OF THE INVENTION

The present invention relates generally to the electronic and computer arts, and, more particularly, to apparatus and methods for bill payment transactions, such as consumer and/or business bill payment transactions, and the like.

### BACKGROUND OF THE INVENTION

A number of existing systems seek to enhance convenience and efficiency of electronic payments. MasterCard International Incorporated of Purchase, N.Y. currently offers MasterCard Remote Payment and Presentment Services (RPPS® brand provision of secure electronic delivery of billing remittance data and funds).

U.S. Pat. No. 5,699,528 to Hogan discloses a system and method for bill delivery and payment over a communications network. In a bill delivery and payment system, users are able to access a server computer on a communications network to obtain bill information and pay bills. For example, such a communications network may be the Internet or the World Wide Web thereof. Using a personal computer, a user can access a Web site provided by the server computer to view the bill information and instruct the server computer as to the details of the bill payment. In a second embodiment, without visiting the web site, users are provided with electronic bills containing bill information in the form of electronic mail (e-mail) at their e-mail addresses. After opening an electronic bill, a user can make the bill payment by replying to the electronic bill.

### SUMMARY OF THE INVENTION

Principles of the present invention provide techniques related to a transaction processing engine for consumer bill payment transactions and the like. At least some aspects of the techniques may be facilitated by the operator of a payment network or other service provider.

In one aspect, an exemplary method includes obtaining, by an operator of a payment processing network, from a plurality of customer service providers, a first plurality of messages specifying a plurality of bill payments to a plurality of biller entities, the first plurality of messages specifying, for each of the bill payments, an amount and an intended one of the biller entities to be paid; based on the first plurality of messages, dispatching, by the operator of the payment processing network, to the plurality of biller entities, a second plurality of messages to initiate the plurality of bill payments; and obtaining, by the operator of the payment processing network, at least one of:
first data from at least one of the plurality of customer service providers specifying when at least some of the first plurality of messages specifying the plurality of bill payments to the plurality of biller entities are to be obtained by the operator of the payment processing network; and
second data from at least one of the plurality of biller entities specifying when at least some of the second plurality of messages to initiate the plurality of bill payments are to be dispatched.

The operator of the payment processing network carries out at least one of:
scheduling the step of obtaining the first plurality of messages specifying the plurality of bill payments to the plurality of biller entities in accordance with the first data; and
scheduling the step of dispatching the second plurality of messages in accordance with the second data.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer program product including a tangible computer readable recordable storage medium with computer usable program code for performing the method steps indicated stored thereon in a non-transitory manner. Furthermore, one or more embodiments of the invention or elements thereof can be implemented in the form of a system (or apparatus) including a memory and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) specialized hardware module(s), (ii) software module(s) stored in a non-transitory manner in a tangible computer-readable recordable storage medium (or multiple such media) and implemented on a hardware processor, or (iii) a combination of (i) and (ii); any of (i)-(iii) implement the specific techniques set forth herein.

One or more embodiments of the invention can provide substantial beneficial technical effects, including any one, some, or all of the following:
Horizontal scalability,
Formats definition is not embedded in the code and the core transaction processing is agnostic of formats,
Reuse of the business rules for newer or enhanced services,
Near real time transaction processing, architected & designed for global market (including capability to handle non US currencies, dates, languages, and the like).

These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 shows an example of a payment system;

FIG. 2 depicts an exemplary inter-relationship between and among: (i) a payment network configured to facilitate transactions between multiple issuers and multiple acquirers, (ii) a plurality of users (e.g., consumers or payors), (iii) a plurality of merchants, (iv) a plurality of acquirers, and (v) a plurality of issuers;

FIG. 3 shows exemplary operation of a current bill payment system;

FIG. 4 shows exemplary operation of current automated clearinghouse payments;

FIG. 5 depicts exemplary system interfaces, according to an aspect of the invention;

FIG. 6 depicts an exemplary workflow developer stack, according to an aspect of the invention;

FIG. 7 depicts an exemplary system block diagram, according to an aspect of the invention;

FIG. 8 depicts an exemplary detailed transaction flow, according to an aspect of the invention;

FIG. 9 depicts an exemplary outbound data flow, according to an aspect of the invention;

FIG. 10 depicts an exemplary message flow for outbound file processing, according to an aspect of the invention;

FIG. 11A depicts exemplary data from inbound files in block form, according to an aspect of the invention;

FIG. 11B depicts exemplary data from inbound files in tabular form, according to an aspect of the invention;

FIG. 12 depicts an exemplary confirmation queuing process, according to an aspect of the invention;

FIG. 13 depicts an exemplary remittance queuing process, according to an aspect of the invention;

FIG. 14A depicts exemplary daily schedule generation, according to an aspect of the invention;

FIG. 14B depicts exemplary daily schedule data, according to an aspect of the invention;

FIG. 15 depicts an exemplary schedule daemon process, according to an aspect of the invention;

FIG. 16 presents a flow chart for exemplary task list initiation when window events are present, according to an aspect of the invention;

FIG. 17 depicts an exemplary build outbound files process, according to an aspect of the invention;

FIG. 18 depicts exemplary tracing between inbound and outbound data, according to an aspect of the invention;

FIG. 19 depicts exemplary bill payment outbound data flow, according to an aspect of the invention;

FIG. 20 depicts sample SIF/SINF status records and sample SIF detail records, according to an aspect of the invention;

FIG. 21 depicts an exemplary end of day process, according to an aspect of the invention;

FIG. 22 depicts an exemplary portfolio conversion process, according to an aspect of the invention;

FIG. 23 depicts an exemplary stop file workstream, according to an aspect of the invention;

FIG. 24 depicts an exemplary business layer, according to an aspect of the invention;

FIG. 25 depicts an exemplary start up and initialization process, according to an aspect of the invention;

FIG. 26 depicts an exemplary utility class, according to an aspect of the invention; and

FIG. 27 is a block diagram of an exemplary computer system useful in one or more embodiments of the invention.

### DETAILED DESCRIPTION OF PREFERRED EMBODIMENTS

Inventive techniques can be employed in a number of different environments. In one or more embodiments, inventive techniques can be employed in connection with the MASTERCARD RPPS® electronic payment system of MasterCard International Incorporated of Purchase, N.Y., USA. This example is non-limiting; for example, other types of electronic bill payment systems could be employed in other instances. Thus, references to RPPS in one or more embodiments are not intended to be limiting and other embodiments may be employed in connection with other types of electronic payment systems.

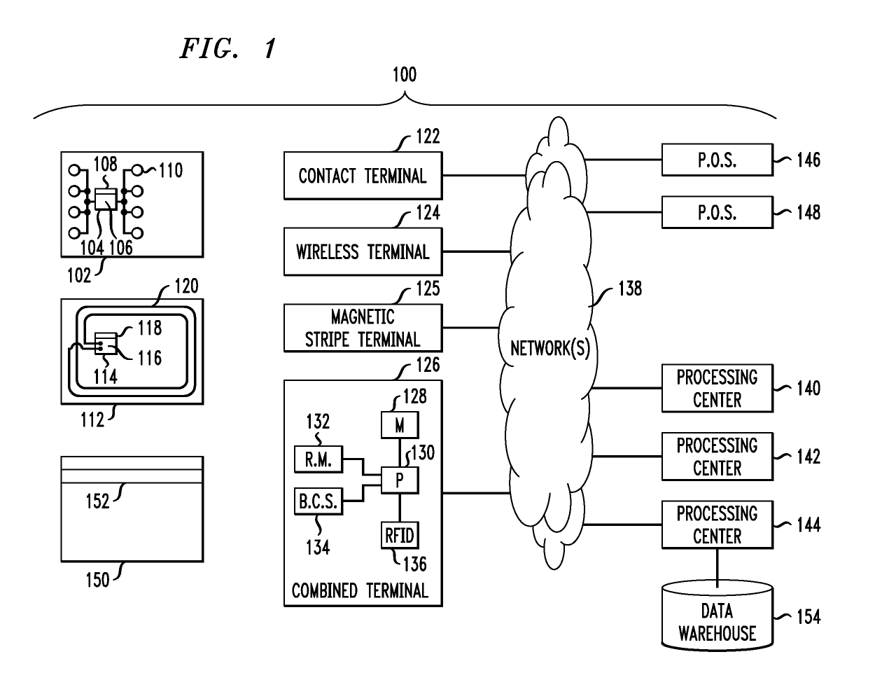

FIG. 1 is provided for exemplary purposes and depicts physical interface of cards with terminals, but it should be understood that in one or more instances of the invention, a consumer or customer may simply provide card account information to an entity via telephone, web site, and the like, without physically scanning the card at a terminal. Indeed, in some instances, payment is made by electronic funds transfer (EFT) rather than with a payment card. However, platforms in accordance with one or more embodiments can be utilized for other transaction types, such as, for example, debt management proposals, bill presentment, and the like.

Attention should now be given to FIG. 1, which depicts an exemplary embodiment of a system 100, including various possible components of the system. System 100 can include one or more different types of portable payment devices. For example, one such device can be a contact device such as card 102. Card 102 can include an integrated circuit (IC) chip 104 having a processor portion 106 and a memory portion 108. A plurality of electrical contacts 110 can be provided for communication purposes. In addition to or instead of card 102, system 100 can also be designed to work with a contactless device such as card 112. Card 112 can include an IC chip 114 having a processor portion 116 and a memory portion 118. An antenna 120 can be provided for contactless communication, such as, for example, using radio frequency (RF) electromagnetic waves. An oscillator or oscillators, and/or additional appropriate circuitry for one or more of modulation, demodulation, downconversion, and the like can be provided. Note that cards 102, 112 are exemplary of a variety of devices that can be employed. Other types of devices could include a conventional card 150 having a magnetic stripe 152, an appropriately configured cellular telephone handset, and the like. Indeed, techniques can be adapted to a variety of different types of cards, terminals, and other devices, configured, for example, according to a payment system standard (and/or specification).

The ICs 104, 114 can contain processing units 106, 116 and memory units 108, 118. Preferably, the ICs 104, 114 can also include one or more of control logic, a timer, and input/output ports. Such elements are well known in the IC art and are not separately illustrated. One or both of the ICs 104, 114 can also include a co-processor, again, well-known and not separately illustrated. The control logic can provide, in conjunction with processing units 106, 116, the control necessary to handle communications between memory unit 108, 118 and the input/output ports. The timer can provide a timing reference signal from processing units 106, 116 and the control logic. The co-processor could provide the ability to perform complex computations in real time, such as those required by cryptographic algorithms.

The memory portions or units 108, 118 may include different types of memory, such as volatile and non-volatile memory and read-only and programmable memory. The memory units can store transaction card data such as, e.g., a user's primary account number (“PAN”) and/or personal identification number (“PIN”). The memory portions or units 108, 118 can store the operating system of the cards 102, 112. The operating system loads and executes applications and provides file management or other basic card services to the applications. One operating system that can be used is the MULTOS® operating system licensed by licensed by MAOSCO Limited. (MAOSCO Limited, St. Andrews House, The Links, Kelvin Close, Birchwood, Warrington, WA3 7PB, United Kingdom). Alternatively, JAVA CARD™-based operating systems, based on JAVA CARD™ technology (licensed by Sun Microsystems, Inc., 4150 Network Circle, Santa Clara, Calif. 95054 USA), or proprietary operating systems available from a number of vendors, could be employed. Preferably, the operating system is stored in read-only memory (“ROM”) within memory portion 108, 118. In an alternate embodiment, flash memory or other non-volatile and/or volatile types of memory may also be used in the memory units 108, 118.

In addition to the basic services provided by the operating system, memory portions 108, 118 may also include one or more applications. At present, one possible specification to which such applications may conform is the EMV interoperable payments specification set forth by EMVCo, LLC (901 Metro Center Boulevard, Mailstop M3-3D, Foster City, Calif., 94404, USA). It will be appreciated that applications can be configured in a variety of different ways.

In some cases, aspects conform to pertinent ISO standards, such as ISO 8583. Individual entities or groups may develop specifications within this standard.

As noted, cards 102, 112 are examples of a variety of payment devices that can be employed. The primary function of the payment devices may not be payment, for example, they may be cellular phone handsets. Such devices could include cards having a conventional form factor, smaller or larger cards, cards of different shape, key fobs, personal digital assistants (PDAs), appropriately configured cell phone handsets, or indeed any device with the appropriate capabilities. The cards, or other payment devices, can include body portions (e.g., laminated plastic layers of a payment card, case or cabinet of a PDA, chip packaging, and the like), memories 108, 118 associated with the body portions, and processors 106, 116 associated with the body portions and coupled to the memories. The memories 108, 118 can contain appropriate applications. The processors 106, 116 can be operative to facilitate execution of one or more techniques. The applications can be, for example, application identifiers (AIDs) linked to software code in the form of firmware plus data in a card memory such as an electrically erasable programmable read-only memory (EEPROM). Again, note that “smart” cards are not necessarily required and a magnetic stripe card can be employed; furthermore, in some cases no physical presentment of a card to a terminal is required, and in one or more instances, a payment card account with an account number but no physical card could even be employed. Again, in some instances, no use of cards is made and payment is by EFT. All of these scenarios are exemplary and non-limiting.

A number of different types of terminals can be employed with system 100. Such terminals can include a contact terminal 122 configured to interface with contact-type device 102, a wireless terminal 124 configured to interface with wireless device 112, a magnetic stripe terminal 125 configured to interface with a magnetic stripe device 150, or a combined terminal 126. Combined terminal 126 is designed to interface with any type of device 102, 112, 150. Some terminals can be contact terminals with plug-in contactless readers. Combined terminal 126 can include a memory 128, a processor portion 130, a reader module 132, and optionally an item interface module such as a bar code scanner 134 and/or a radio frequency identification (RFID) tag reader 136. Items 128, 132, 134, 136 can be coupled to the processor 130. Note that the principles of construction of terminal 126 are applicable to other types of terminals and are described in detail for illustrative purposes. Reader module 132 can be configured for contact communication with card or device 102, contactless communication with card or device 112, reading of magnetic stripe 152, or a combination of any two or more of the foregoing (different types of readers can be provided to interact with different types of cards e.g., contacted, magnetic stripe, or contactless). Terminals 122, 124, 125, 126 can be connected to one or more processing centers 140, 142, 144 via a computer network 138. Network 138 could include, for example, the Internet, or a proprietary network (for example, a virtual private network, such as the BANKNET® virtual private network (VPN) of MasterCard International Incorporated off Purchase, N.Y., USA. More than one network could be employed to connect different elements of the system. For example, a local area network (LAN) could connect a terminal to a local server or other computer at a retail establishment. A payment network could connect acquirers and issuers. Processing centers 140, 142, 144 can include, for example, a host computer of an issuer of a payment device (or processing functionality of other entities discussed in other figures herein).

Many different retail or other establishments, as well as other entities, generally represented by points-of-sale 146, 148, can be connected to network 138. Each such establishment can have one or more terminals. Further, different types of portable payment devices, terminals, or other elements or components can combine or “mix and match” one or more features depicted on the exemplary devices in FIG. 1.

Portable payment devices can facilitate transactions by a user with a terminal, such as 122, 124, 125, 126, of a system such as system 100. Such a device can include a processor, for example, the processing units 106, 116 discussed above. The device can also include a memory, such as memory portions 108, 118 discussed above, that is coupled to the processor. Further, the device can include a communications module that is coupled to the processor and configured to interface with a terminal such as one of the terminals 122, 124, 125, 126. The communications module can include, for example, the contacts 110 or antennas 120 together with appropriate circuitry (such as the aforementioned oscillator or oscillators and related circuitry) that permits interfacing with the terminals via contact or wireless communication. The processor of the apparatus can be operable to perform one or more steps of methods and techniques. The processor can perform such operations via hardware techniques, and/or under the influence of program instructions, such as an application, stored in one of the memory units.

The portable device can include a body portion. For example, this could be a laminated plastic body (as discussed above) in the case of “smart” cards 102, 112, or the handset chassis and body in the case of a cellular telephone.

Again, conventional magnetic stripe cards 150 can be used instead of or together with “smart” or “chip” cards, and as noted in some cases, a card account with no physical card can be employed. Yet again, in some instances, no use of cards is made and payment is by EFT. All of these scenarios are exemplary and non-limiting.

It will be appreciated that the terminals 122, 124, 125, 126 are examples of terminal apparatuses for interacting with a payment device of a holder. The apparatus can include a processor such as processor 130, a memory such as memory 128 that is coupled to the processor, and a communications module such as 132 that is coupled to the processor and configured to interface with the portable apparatuses. The processor 130 can be operable to communicate with portable payment devices of a user via the communications module 132. The terminal apparatuses can function via hardware techniques in processor 130, or by program instructions stored in memory 128. Such logic could optionally be provided from a central location such as processing center 140 over network 138. In some instances, the aforementioned bar code scanner 134 and/or RFID tag reader 136 can be provided, and can be coupled to the processor, to gather data, such as a product identification, from a UPC code or RFID tag on a product to be purchased.

The above-described devices 102, 112 can be ISO 7816-compliant contact cards or devices or NFC (Near Field Communications) or ISO 14443-compliant proximity cards or devices. In operation, card 112 can be touched or tapped on the terminal 124 or 126, which then contactlessly transmits the electronic data to the proximity IC chip in the card 112 or other wireless device. Magnetic stripe cards can be swiped in a well-known manner. Again, in one or more instances, the card number is simply provided via telephone, web site, or the like. Yet again, in some instances, no use of cards is made and payment is by EFT. All of these scenarios are exemplary and non-limiting.

One or more of the processing centers 140, 142, 144 can include a database such as a data warehouse 154 for storing information of interest. Network(s) 138 could, as noted, include a virtual private network (VPN) and/or the Internet; the VPN could be, for example, the aforementioned BANKNET® network.

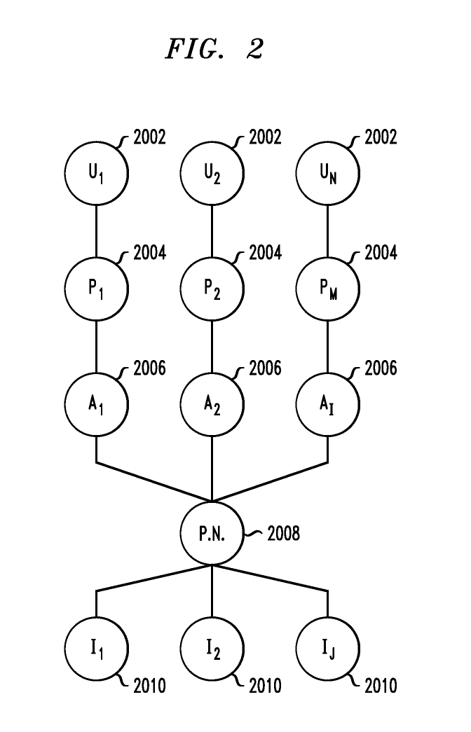

With reference to FIG. 2, an exemplary relationship among multiple entities is depicted in the context of a card payment process. Some embodiments involve payment by electronic funds transfer; however, in some instances, exemplary methods are carried out by an operator of a payment processing network and/or exemplary systems are provided and/or operated by an operator of a payment processing network. Entity 2008 in FIG. 2 is a non-limiting example.

A number of different users 2002, U₁, U₂ . . . U_{N}, interact with a number of different merchants 2004, P₁, P₂ . . . P_{M}. Users 2002 could be, for example, consumers, payors, or other holders of payment cards. Merchants 2004 interact with a number of different acquirers 2006, A₁, A₂ . . . A_{I}. Acquirers 2006 interact with a number of different issuers 2010, I_{I}, I₂ . . . I_{J}, through, for example, a single operator 2008 of a payment network configured to facilitate transactions between multiple issuers and multiple acquirers; for example, MasterCard International Incorporated, operator of the BANKNET® network, or Visa International Service Association, operator of the VISANET® network. In general, N, M, I, and J are integers that can be equal or not equal.

During a conventional credit authorization process, the cardholder 2002 pays for the purchase and the merchant 2004 submits the transaction to the acquirer (acquiring bank) 2006. The acquirer verifies the card number, the transaction type and the amount with the issuer 2010 and reserves that amount of the cardholder's credit limit for the merchant. Authorized transactions are stored in “batches,” which are sent to the acquirer 2006. During clearing and settlement, the acquirer sends the batch transactions through the credit card association, which debits the issuers 2010 for payment and credits the acquirer 2006. Once the acquirer 2006 has been paid, the acquirer 2006 pays the merchant 2004.

It will be appreciated that the network 2008 shown in FIG. 2 is an example of a payment network configured to facilitate transactions between multiple issuers and multiple acquirers, which may be thought of as an “open” system. In other instances, a payment network configured to facilitate transactions between multiple issuers and a single acquirer could be used. Some embodiments of the invention may be employed with other kinds of payment networks, for example, proprietary or closed payments networks with only a single issuer and acquirer.

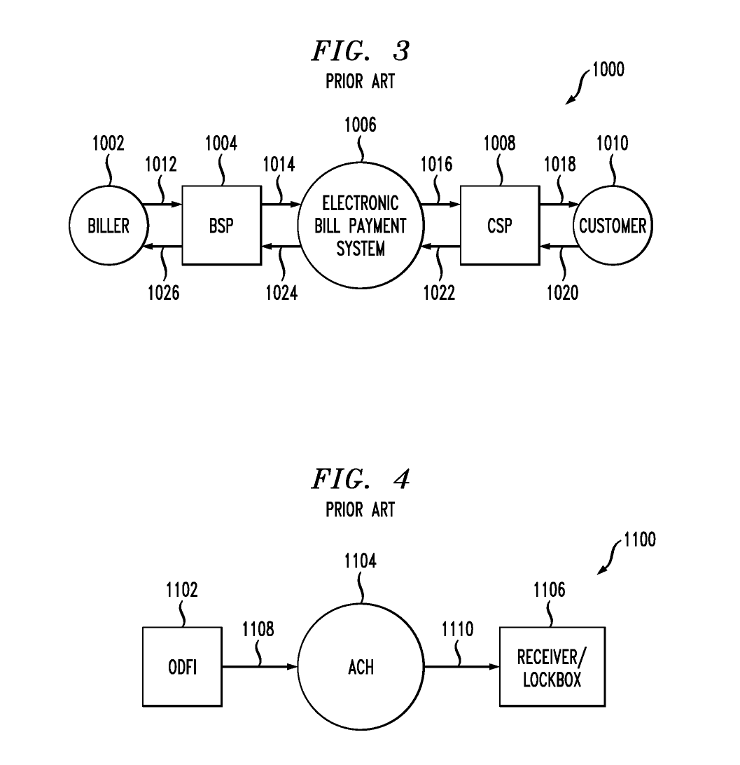

FIG. 3 shows operation of a current electronic bill payment system, such as the MASTERCARD RPPS® electronic payment system, which is but one non-limiting example of such a system. Given the teachings herein, the skilled artisan will be able to implement one or more embodiments of the invention using a variety of techniques; by way of example and not limitation, the modification or supplementing of an existing system such as that shown in FIG. 3 using techniques described herein, or the complete replacement of such a system, in other instances. As shown in FIG. 3, in a current approach 1000, during a presentment phase, a biller 1002 electronically sends billing information 1012 to its biller service provider (BSP) 1004; that is, an institution that acts as an intermediary between the biller and the consumer for the exchange of electronic bill payment information. BSP 1004 in turn sends the information to the electronic bill payment system 1006, as seen at 1014. As seen at 1016, the system 1006 in turn delivers the billing information to the customer service provider (CSP) 1008, that is, an agent of the customer that provides an interface directly to customers, businesses, or others for bill payment and presentment. The CSP enrolls customers, enables payment and presentment, and provides customer care. CSP 1008 presents the bill to the consumer (customer) 1010 at 1018.

In a payment phase, consumer 1010 sends bill payment instructions to CSP 1008, as seen at 1020. CSP 1008 in turn sends the bill payment information to the system 1006, as at 1022. The system sends funds and data electronically to BSP 1004, as at 1024. The BSP 1004 posts payment information to the biller 1002, as at 1026.

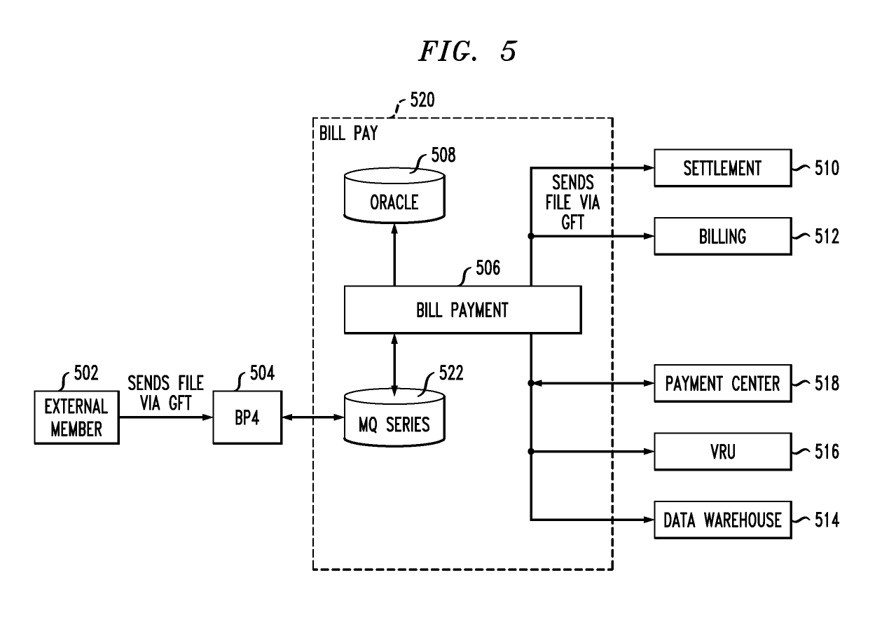

FIG. 4 shows a current process 1100 for making electronic funds transfers (EFT) for bill payment or the like. An originating depository financial institution (ODFI) 1102, also known as an originator, sends instructions (e.g., payment data and remittance data) using a network such as the automated clearing house (ACH) 1104, Swift, EPN, CHIPS, Fedwire, and the like, as seen at 1108. As shown at 1110, the ACH or similar network 1104 relays the instructions to the receiving depository financial institution (RDFI) (e.g., receiver or a lockbox), designated 1106. In some embodiments, an ACH file format can be used; one non-limiting example of an ACH file format is the NACHA ACH CCD file format. Other formats can also be used; for example, extensible markup language (XML). It should be noted that a variety of networks can be used, both public (for example, ACH) and proprietary (for example, the aforementioned MASTERCARD RPPS system).

Currently, to carry out a straight transfer of a file from one party to another, GFT (Global File Transfer) takes advantage of in-place connectivity and does not offer file transfer protocol (FTP) services. A straight transfer may be carried out because of a relationship with a member and a vendor or third party. As will be appreciated by the skilled artisan, GFT is a system available from MasterCard International Incorporated wherein files are transferred over a payment network of the kind shown in FIG. 2, and is a non-limiting example of data file transfer via a payment network. File transfer protocol (FTP) is the standard network protocol used to exchange and manipulate files over an Internet Protocol computer network, such as the Internet. Appropriate file retention and/or billing policies can be set within a GFT network or other network.

There are a number of methods of passing a file through a payment system; for example:
a virtual private network (VPN) such as shown in FIG. 2 (e.g., the Banknet® network)
Internet—using a suitable secure technique for communicating data over the Internet, for example, an existing method such as MasterCard International Incorporated's MFE (MASTERCARD FILE EXPRESS) or the well-known secure file transfer protocol (SFTP) technique or similar techniques. As will be appreciated by the skilled artisan, the same are generally representative of so-called Straight-Through-Processing (STP) techniques which enable electronic payments to flow seamlessly from, for example, a company's Accounts Payable system, through the banking infrastructure, and to a vendor's Accounts Receivable system. Note that in at least some instances, STP techniques can also be employed in connection with the above-discussed VPN file transfer. The Straight Through Processing Transaction Set 820 (hereafter “STP 820”) was developed by the Electronic Payments Network and represents a widely adopted standardized format that may be employed in one or more embodiments. The skilled artisan will appreciate that “820” in this context is a transaction set, not a reference to reference character 820 in the figures. The skilled artisan will also appreciate that MasterCard File Express is an example of an application accessible online which handles both the compression and encryption of data for transmission, using, for example, the International Data Encryption Algorithm (IDEA) encryption scheme.

As noted, in one or more embodiments, inventive techniques can be employed in connection with the MASTERCARD RPPS® electronic payment system of MasterCard International Incorporated of Purchase, N.Y., USA. The RPPS application was initially developed to support remote banking payments and since has been extensively modified to provide additional functionality and to support new lines of business.

One or more embodiments process payments (e.g., electronic funds transfer “EFT”) in a batch mode, edit the information received from payment originators to ensure completeness, feed a settlement system (for example, one operated and/or provided by a payment network operator such as MasterCard International Incorporated of Purchase, N.Y., USA), feed a billing system (for example, one operated and/or provided by a payment network operator such as MasterCard International Incorporated of Purchase, N.Y., USA), and forward remittance information to a party such as, for example, a concentrator representing the biller.

One or more embodiments are supported by various web applications. In some instances, these web applications are largely standalone and not integrated; other approaches can be used in other instances. Non-limiting examples of web applications include:
Online Biller/Creditor Directory—Houses significant customer processing parameters which are employed for successful payment edits and processing in the payment engine
CSR Tool—the CSR (Customer Support Reprehensive) tool is a utility used by a suitable business team for a variety of system support functions, including but not limited to management of system and customer parameters, provisioning of users for the Biller Directory; supporting settlement services for funds verification; managing Biller Directory content and screens; and/or for supporting customer testing efforts and validation of test results
eService-based payments center online research facility—an application that helps customers research their transactions, return them to the sender and view their wire transfer activity

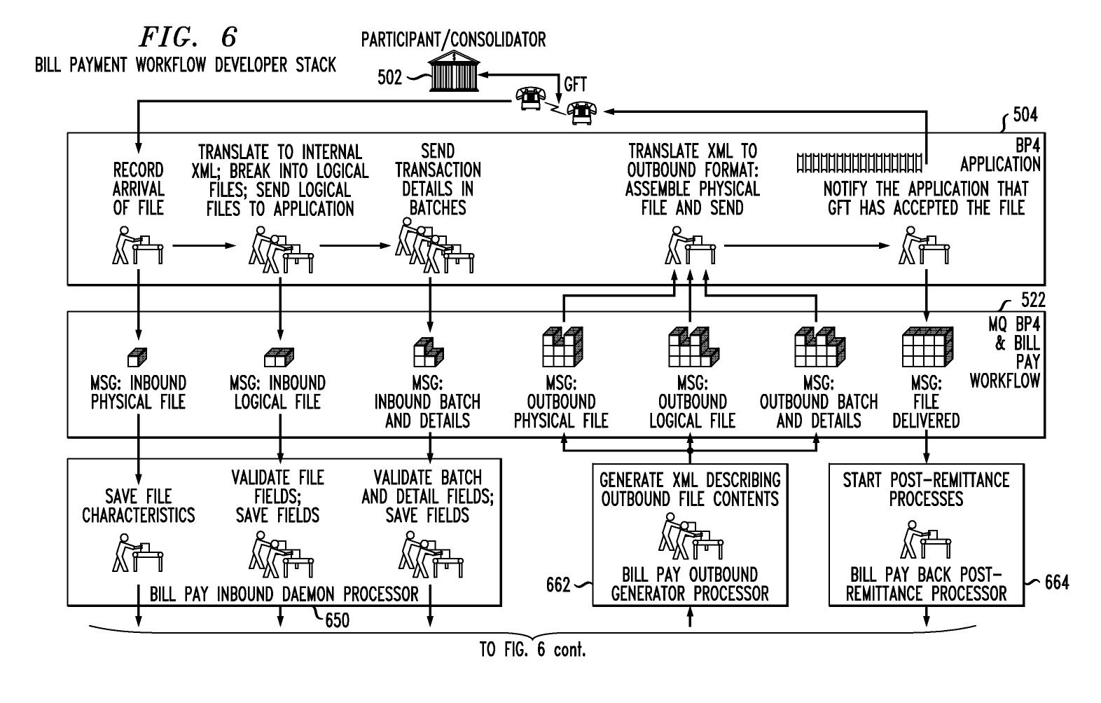

Non-limiting exemplary system architecture will now be described. With reference to FIG. 5, the bill payment inbound preprocessor, BP4 (BP4=bill payment pre & post processing is a component on the bill payment platform that manages directing and translating the transactions to and from customers), numbered 504, receives data from GFT (e.g., from external member 502). After file integrity and data integrity checks, the bill payment inbound preprocessor communicates the file level fields to the bill payment business rules processor 506. The fields are saved into the bill payment relational database 508 and validated. If the file level validation results in a status of accepted, the bill payment inbound preprocessor communicates the batch data (along with the detail transactions contained in the batch) one by one to the bill payment business rule processor. Again, the fields are saved into the bill payment relational database and validated. When the process is finished, the relational database has all data needed to issue confirmation, remittance, settlement 510, billing 512, data warehouse 514, voice response unit (VRU) 516, and payment center 518 files. One of the last actions that the business rules validation takes is to post a message saying that there are transactions available for downstream processes.

As depicted in FIG. 5, the bill payment system 520 interfaces with BP4 application 504 and communicates via MQ Series® messaging 522 (registered mark of International Business Machines Corporation, Armonk, N.Y., USA); furthermore, in a non-limiting embodiment, the bill payment database 508 is hosted on an ORACLE® database (registered mark of Oracle Corporation, Redwood Shores, Calif., USA). Other messaging and/or database software can be used in other cases.

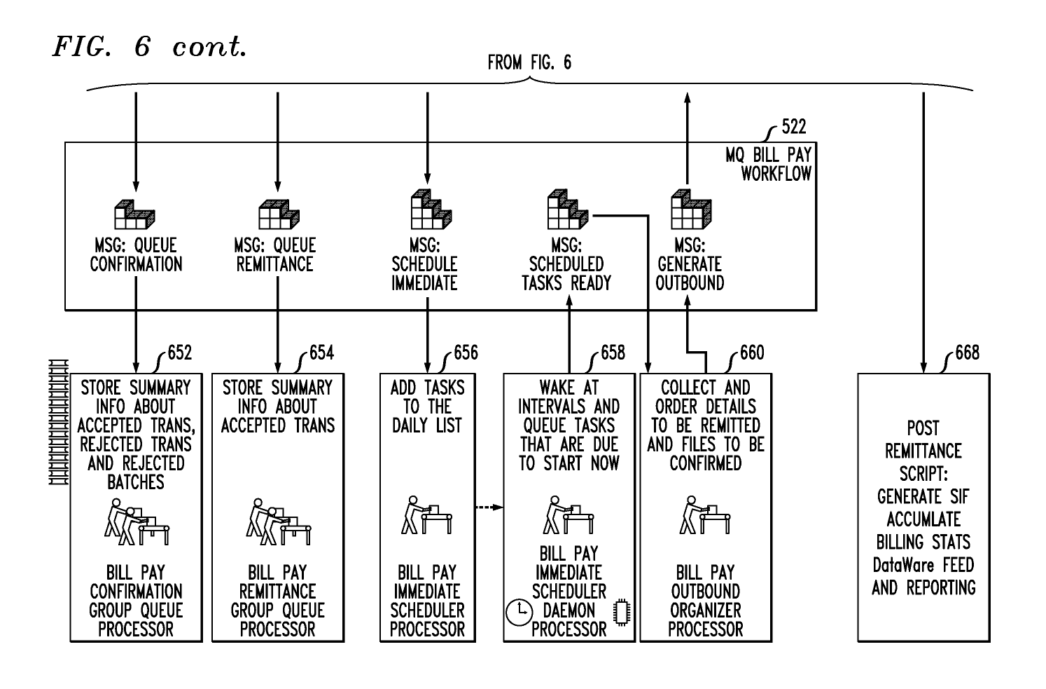

FIG. 6 shows an exemplary bill payment application and workflow in the form of an exemplary path of an EFT file and transactions within bill payment. It shows the touch-points between BP4, bill payment processors, and MQ interaction.

Discussion of exemplary bill payment processors will now be provided.

The inbound daemon processor 650 reads the messages from the request queue, processes the data and persists to the database. After successfully processing the inbound data, it queues up work in the internal queues such as the confirmation queue, remittance queue, immediate schedule queue, and the like. Once it is done with processing the inbound file and batch data, it performs several post process tasks. For example; query the file and verify the batch count. If this batch is the last batch for that file, then it implies that file inbound processing is complete, and it is time to kick off other downstream processing tasks such as confirmation queuing. Another post process task is monitor processing.

In a non-limiting example, the bill payment inbound daemon processor 650 can receive 3 types of request messages from the BP4 inbound process:
Physical file message
Logical File message/File message
Batch message

Bill payment inbound daemon processor 650 reads the messages from the request queue, processes the data and persists it to the database. After successfully processing the inbound data, it queues up work in the internal queues such as the confirmation queue, remittance queue, immediate schedule queue, reporting queue, and the like.

When the business rule validation is complete, three messages are sent to the workflow from the inbound daemon processor 650. These messages are delivered independently of each other. The actions produced by the messages may run at the same time as other processes in the system as they are only dependent on data generated before the messages are delivered.

The confirmation group queue processor 652 reads the internal work message from the confirmation queue, fetches the file ID, and begins the confirmation group queue processor.

The remittance group queue processor 654 reads the internal work message from the remittance queue, fetches the file ID, and begins the remittance group queue processor.

The immediate schedule processor 656 reads the internal work message from the immediate schedule queue, fetches the file ID, and begins the immediate schedule processor. The processor sends a message when it has identified work that needs to be done “right now.”

The scheduler daemon processor 658 wakes up at intervals and checks the task list table to see if there are any tasks to be done immediately. If so, it will send an outbound ready message to the outbound organizer processor 660 as follows; with no attributes and puts the message in the outbound ready queue 799.

<internalwork worktype=“BeginOutbounding”>
</internalwork>

Any business data is preferably passed via the attribute list in the internal work object. For example, when an inbound process is done with processing and when it verifies that the inbound file has completed in-bounding the data, it puts an

<internalwork> (with an <inboundfileid> attribute in it)
to a list of internal processes, such as confirmation queuing, remittance queuing, scheduler daemon, and reporting process.

The bill payment scheduler daemon processor 658, once it identifies that there are tasks to be done by the outbound organizer processor 660, puts an internal work object (in a non-limiting exemplary embodiments, at present no attributes are identified) in the outbound ready queue.

The outbound organizer processor 660 process builds the outbound files and produces messages that the bill payment outbound generator processor 662 uses to send the files to the participants 502. Three messages are sent—outbound physical file, outbound logical file, and outbound batch and details.

The outbound generator processor 662 reads the messages in the outbound organizer processor ready queue. If an outbound ready message exists, then this processor 662 starts generating the outbound data and will queue up the data in the outbound tables. It then reads the data from these table(s), and generates work request message(s) to the BP4 system 504.

With regard to the back post remittance processor 664, this process includes creation of transaction feeds to settlement, billing and data warehouse. Items in FIG. 6 labeled 504 and 522 are the same as the analogous things in FIG. 5.

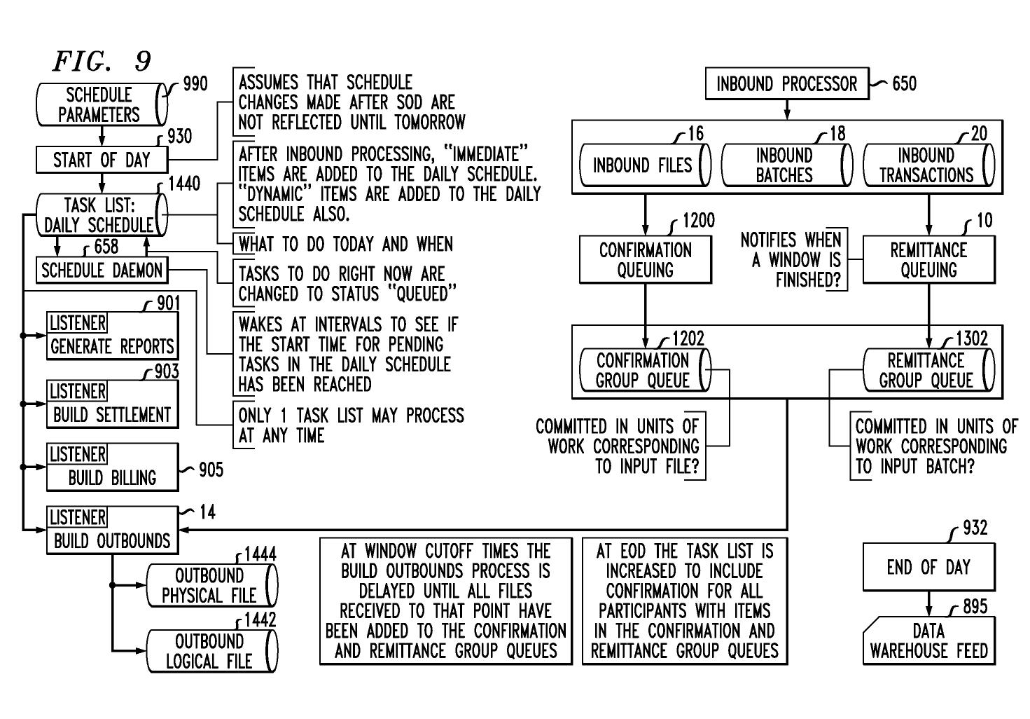

The processors within the bill payment system preferably communicate with each other using internal work object representation. When a process is done with its processing, it might put an internal work message in the queue, and the other process listening to the messages in the queue will start processing after reading the internal work message. For example, the inbound process will generate the internal work instances and put the message in the confirmation queue, remittance queue, and immediate schedule queue respectively. See also FIG. 9 wherein listening to task list 1440 is used to generate reports, build settlements, build billing, and build outbounds, as at 901, 903, 905 and 14, respectively. Presented below is exemplary information regarding the types of MQ queues.

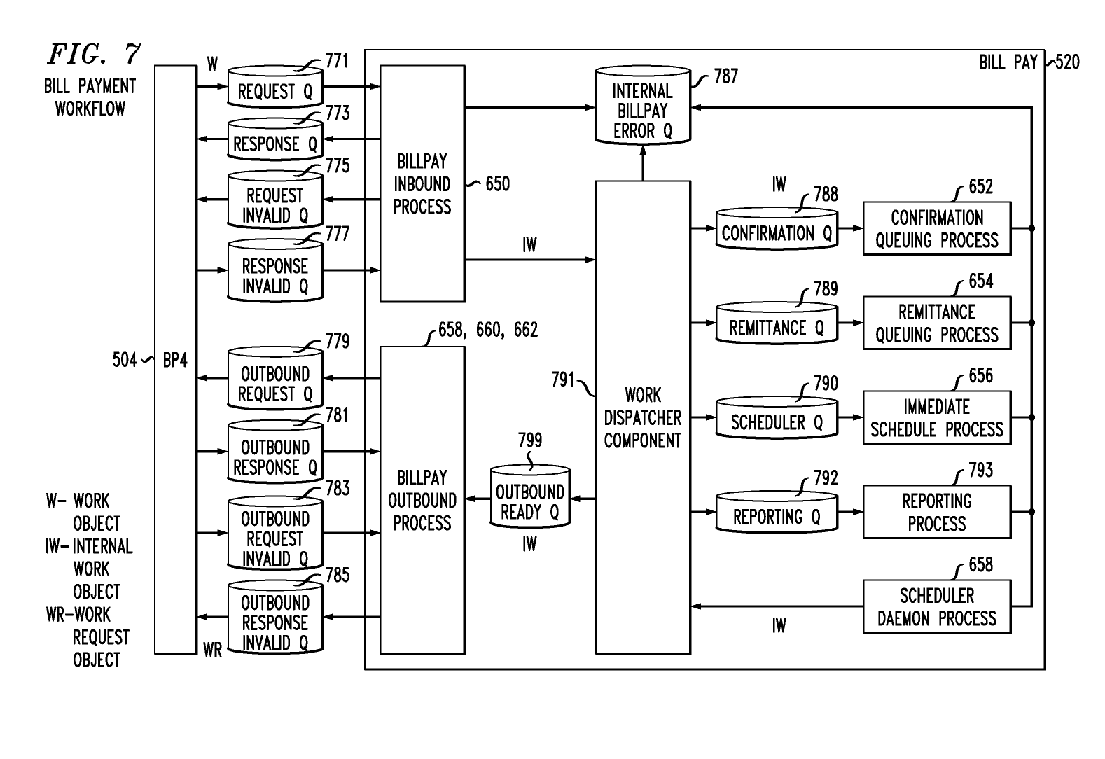

The MQ BP4/bill payment inbound queues include (see FIG. 7):
The request queue 771 is a logical queue that holds the work messages input by BP4 504 for bill payment 520 to process.
The response queue 773 is a logical queue, to which bill payment 520 puts response messages back after successfully processing the inbound data.
The request invalid queue 775 is a logical queue, when bill payment 520 identifies any errors pertaining to the BP4 work message format. The bill payment application puts the messages in this queue. The messages in this queue pertain to any BP4 work format errors in the message and not to bill payment system errors.
The response invalid queue 777 is employed if BP4 did not receive the message in the format it is expecting (valid format), if so then BP4 might place the response sent by bill payment in a response invalid queue

The MQ BP4/bill payment outbound queues include:
The outbound request queue 779 is a logical queue that holds work request messages put by the bill payment outbound process. BP4 504 picks the messages from this queue, and prepares an outbound file, to be sent to the customer.
The outbound response queue 781 is a logical queue that holds response messages to the work request messages, sent by BP4 process 504.
The outbound request invalid queue 783 is a logical queue that holds invalid work request messages, sent by bill payment 520.
The outbound response invalid queue 785 is a logical queue that holds invalid work request response messages, sent by BP4 504.

The MQ bill payment Internal Workflow Queues include:
Error queue 787: messages are written to this queue when a bill payment system error or any exception occurs while processing the inbound data, confirmation queuing, remittance queuing, and the like.
The confirmation queue 788 is an internal queue that is used for processing internal work within bill payment. Messages in this queue are queued up for pick up and processing by the confirmation queuing process. (Note that “bill pay” or “the bill pay system” or “bill payment” or “the bill payment system” is used herein as a shorthand for one or more exemplary, non-limiting embodiments; furthermore, “bill payment” is generally used herein for consistency instead of “bill pay” as was employed in U.S. Provisional Patent Application Ser. No. 61/438,106.)
The remittance queue 789 is an internal queue that is used for processing internal work within bill payment. Messages in this queue are queued up for pick up and processing by the remittance queuing process.
The immediate schedule queue 790 is an internal queue that is used for processing internal work within bill payment. Messages in this queue are queued up for pick up and processing by the immediate schedule queuing process 656.
The reporting queue 792 is an internal queue that is used for processing internal work within bill payment. Messages in this queue are queued up for pick up and processing by the reporting process 793.

Work dispatcher 791 is discussed below.

Exemplary bill payment support components include post remittance script 668 which generates the settlement in full (SIF) file and accumulates billing statistics.

It should be noted that in some instances, flags for payments addenda may be set to “no” where payments with addenda are not allowed. Other instances may permit such addenda.

In one or more embodiments, a series of lookup tables is employed to contain valid values for file, batch and detail fields. These tables are used instead of hard-coding values in the program. A separate table is not needed for each field—a generic set of tables can be provided to cover lookups. Some fields have only single lookup values. Other fields have lookups keyed on multiple inputs (relations between this field and another field).

Note that fixed outbound formats could have overflows in the amount totals.

One or more embodiments may include capability to design reports for audit and exception reporting to aid customer support.

In one or more embodiments, the bill payment inbound preprocessor is capable of breaking a physical file into multiple logical files, as shown at 504. Furthermore, the bill payment inbound preprocessor, in at least some instances, passes the number of rejected batches in the file message in addition to the number of total batches; the bill payment inbound preprocessor is capable of determining the bulk type (a label that defines the physical characteristic of files that are exchanged to & from customers), file name and deliver date/time for files associated with the specific file IDs (workflow IDs). Alternately, the preprocessor provides a workflow for re-queuing a file for input; in some instances, the re-queuing would only apply to files received on the current processing day.

In one or more embodiments, Focus is employed to determine the record type based on field 1 on the transaction detail/addenda record in combination with the record type of the parent record in the file structure hierarchy. UMT (or FOCUS) is a Universal Message Translator that translates messages to and from the customer's format to the application's generic format. This allows the core business processing logic to be format agnostic.

One or more embodiments interface with other applications, either internal or external to bill payment. Most, but not all, of these “interfaces” involve data interfaces. Areas where non-data related changes to other applications are required may also be present in some instances.

The below table presents a non-limiting exemplary summary of interfaces, and documents, for a non-limiting exemplary embodiment, all the interfaces that the application platform has with customers and/or internal applications.

| | | | | | | | Other |
|---|---|---|---|---|---|---|---|
| | Interface | | | | | | Impacted |
| Interface # | Description | InTernal | External | Input | OutPut | Interface Type | Departments |
| 1 | MOD-CIE | ✓ | ✓ | ✓ | ✓ | File | File Transfer |
| 2 | ACH-CIE | ✓ | ✓ | ✓ | ✓ | File | File Transfer |
| 3 | Common Globa | ✓ | ✓ | ✓ | ✓ | Message | File Transfer |
| 4 | File validation and | ✓ | | ✓ | | Java jar | File Transfer |
| | conversion | | | | | | |
| 5 | File workflow | ✓ | | ✓ | ✓ | MQ | File Transfer |
| | message | | | | | | |
| 6 | Batch workflow | ✓ | | ✓ | ✓ | MQ | File Transfer |
| | message | | | | | | |
| 7 | Payment Center | ✓ | ✓ | | ✓ | Browser | eService |
| 8 | Returns Service | ✓ | | ✓ | | Web Service | eService |
| 9 | Data Warehouse | ✓ | ✓ | ✓ | ✓ | Feed File | Data |
| | | | | | | | Warehouse |
| 10 | Portfolio Conversion | ✓ | | ✓ | | Param Synch | <none> |
| | Registration | | | | | | |
| 11 | Portfolio Conversion | | ✓ | ✓ | | File | GFT |
| | Account file | | | | | | GIS |
| 12 | Stop file | ✓ | | ✓ | | Param Synch | <none> |
| | Registration | | | | | | |
| 13 | Account Stop file | | ✓ | ✓ | | File | GFT |
| | | | | | | | GIS |

One or more embodiments may be linked to an appropriate bill payment database model.

One or more embodiments employ a customer-initiated entry (CIE) batch entry description lookup table which defines the valid entries and assigns an ID for each batch with description: ‘RPS PAYMNT’, ‘REVERSAL’, ‘RETURN’, ‘RPS SDAY’, ‘EXCEPTION’, and ‘E PAYMENT’. Again, references to the RPPS system are exemplary and non-limiting.

CIE Batch Entry Description

| Batch Entry ID | Batch Entry Description |
|---|---|
| 1 | RPS PAYMNT |
| 2 | RETURN |
| 3 | REVERSAL |
| 4 | RPS SDAY |
| 5 | EXCEPTION |
| 6 | E PAYMENT |

The CIE service class code lookup table defines the valid entries and associates them back to the batch entry descriptions with which they may appear.

CIE Service Class Code

| Service Class Code | Batch Entry ID |
|---|---|
| 200 | 1 |
| 220 | 1 |
| 200 | 2 |
| 220 | 2 |
| 225 | 2 |
| 200 | 3 |
| 225 | 3 |
| 200 | 4 |
| 220 | 4 |
| 200 | 5 |
| 220 | 5 |

The CIE transaction code lookup table defines the valid entries and associates them back to the service class code.

CIE Transaction Code

| Transaction Code | Service Class Code |
|---|---|
| 21 | 200 |
| 22 | 200 |
| 26 | 200 |
| 27 | 200 |
| 21 | 220 |
| 22 | 220 |

This CIE batch entry to transaction code lookup table defines the valid transaction codes for each batch entry description.

CIE Batch Entry Transaction Code

| Batch Entry ID | Transaction Code |
|---|---|
| 1 | 22 |
| 2 | 21 |
| 3 | 27 |
| 4 | 62 |
| 5 | 22 |
| 6 | 22 |

The date range entity gives the various date ranges needed by the application.

In some cases, it is appropriate to check whether the inbound format is compatible with the biller's outbound format. In some embodiments, all formats are compatible with each other except that inbound ACH-CTX (National Automated Clearing House (NACHA) Corporate Trade Exchange (CTX)) batches must be associated with billers that accept outbound ACH-CTX. Other approaches could be used in other instances.

Non-limiting exemplary actors and use cases for the system will now be described. This view presents the needs of the user by work streams. One or more embodiments include the following components interacting with each other via messages posted through a workflow engine.

In a non-limiting example, the standard payment work stream accounts for more than 80% of the transaction volume through the bill payment system (other embodiments may have different percentages). Furthermore, in some instances, many of the other bill payment work streams flow through standard payment processes as well. Aspects of standard payment processing and the corresponding outbound remittance data, confirmation file, billing, and settlement processes will now be discussed.

In general, the bill payment inbound preprocessor 650 receives data from GFT. After file integrity and data integrity checks, the bill payment inbound preprocessor communicates the file level fields to the bill payment business rules processor 506. The fields are saved into the bill payment relational database 508 and validated. If the file level validation results in a status of accepted, the bill payment inbound preprocessor 650 communicates the batch data (along with the detail transactions contained in the batch) one by one to the bill payment business rule processor 506. Again, the fields are saved into the bill payment relational database and validated. When the process is finished, the relational database 508 has all data needed to issue a confirmation file and remittance files. In one or more embodiments, one of the last actions that the business rules validation takes is to post a message saying that there are transactions available for downstream processes. The bill payment confirmation file and outbound remittance processes will be interested in this message.

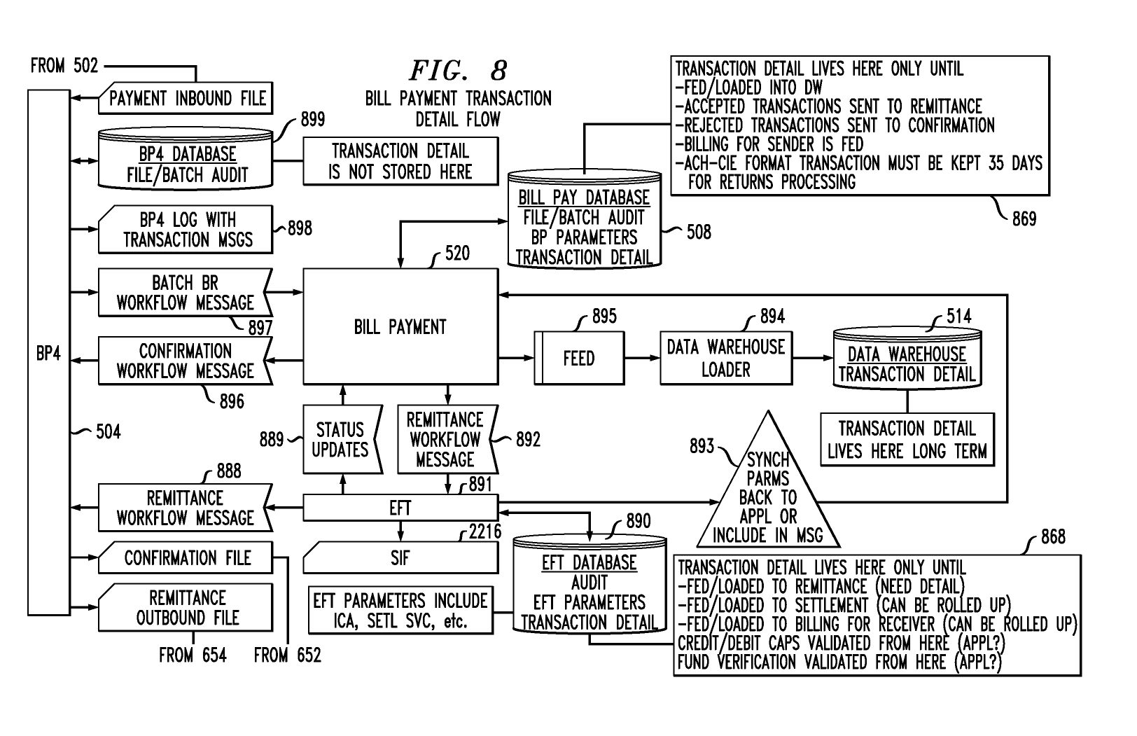

FIG. 8 shows an exemplary flow of detail transaction data within the system and how long those details are stored. Other embodiments may take different approaches. A payment inbound file is received from an external customer 502, by BP4 system 504. A BP4 log with transaction messages is maintained at 898. A BP4 database 899 is maintained for file and/or batch audit. In some embodiments, transaction detail is not stored in database 899. Batch background workflow messaging and confirmation workflow messaging are shown at 897, 896 respectively. See also 522 in FIG. 5. As shown at 895, system 520 feeds data warehouse loader 894 with transaction details to be persisted in data warehouse 514. Bill payment database 508 includes file and/or batch audit details, bill payment parameters, and transaction details. In some embodiments, data is maintained here for a limited period as indicated at 869. Remittance workflow messages 892 effectuate, for example, electronic funds transfer 891. Suitable status updates are returned to system 520 at 899. Remittance workflow message 888 is sent to BP4 system 504; outbound remittance files have been handled at 654 and confirmation files at 652. As shown at 893, parameters from EFT 891 may be synchronized back to system 520 and/or included in messaging. EFT database 890 includes audit data, EFT parameters, and transaction details. In some embodiments, data is maintained here for a limited period as indicated at 868. The SIF file is shown at 2216.

An overview data flow in the bill payment core system is shown in FIG. 9.

In one or more embodiments, significant outbound components include:
Start of Day processor 930
Workflow Messages, such as those discussed elsewhere
Outbound Scheduler processor 658, 660, 662
Confirmation File processor (see, e.g., queuing process 1200, 1202)
Remittance File processor (see, e.g., queuing process 10, 1302)
End of Day processor 932

Start of Day Process: This process 930 performs tasks to be performed at the start of each processing day. In some cases, each originator has a daily credit cap amount, and the accumulated net amount of transactions from the originator received during the processing day may not exceed this cap. In one or more instances, a table will be set up to keep track of the running net credit amount used for the day. The following fields are available in the table, in an example:

| Field | Start of Day Initialization Value |
|---|---|
| RPPS ID of the originator | From the parameter data |
| Insert date and time of this row | The current date and time |
| Running net credit amount used today | Zero (0.0) |
| File ID that was processed to bring | Zero (0) |
| remainder to this amount | |
| Credit amount present in this file | Zero (0.0) |

When a temporary credit cap update is made to allow inbounds to process, there is preferably an option for the entry of an expiration date associated with the new cap. At start of day, the caps that are expired will typically be rolled back to their previous values.

In the following illustrative example the credit cap amount for the participant is set at 1800. (The skilled artisan will appreciate that 1800 in this context is a value and not a reference character.) On Jun. 19, 2008, the participant has a particularly busy day and needs to temporarily update the cap amount. Support staff raises the cap to 3000, but sets the expiration date time to the next start of day. The original amount of 1800 is put as the default cap amount. Then the start of day procedures on Jun. 20, 2008 detect that the row is expiring and so insert the third row to revert the cap amount back to normal.

Credit Cap Profile

| | | | Last | Last | | Default | |
|---|---|---|---|---|---|---|---|
| | Cap | Effective | Up-dated | updated | Expire | Cap | |
| Participant | Amt | DTM | DTM | user Id | DTM | Amt | Comments |
| P1 | 1800 | 1/1/2008 | 12/28/2007 | Support1 | <null> | <null> | Original |
| | | 2:00 am | 9:33 am | | | | set up |
| P1 | 3000 | 6/19/2008 | 6/19/2008 | Support2 | 6/20/2008 | 1800 | Emergency |
| | | | 11:42 am | | 2:00 am | | update |
| P1 | 1800 | 6/20/2008 | 6/20/2008 | BillPay | <null> | <null> | Auto inserted |
| | | 2:00 am | 2:18 am | | | | by start of day |

The configuration data is information that is specific to the bill payment application in general:
Number of processing days into the past that will be accepted as a transmission date on file header record
Number of processing days into the past that should be considered in duplicate file check
Format type to bulk type association. The format type is code from the FILE FORMAT table. The bulk type is the GFT bulk type used to transmit an inbound file of that format type to an entity such as the operator of a payment processing network (e.g., MasterCard International Incorporated of Purchase, N.Y., USA)
Central site destination
Duplicate file exclusion list

Elements 14, 16, 18, 20, 901, 903, 905, 990, 1440, 1442, and 1444 in FIG. 9 are discussed elsewhere herein.

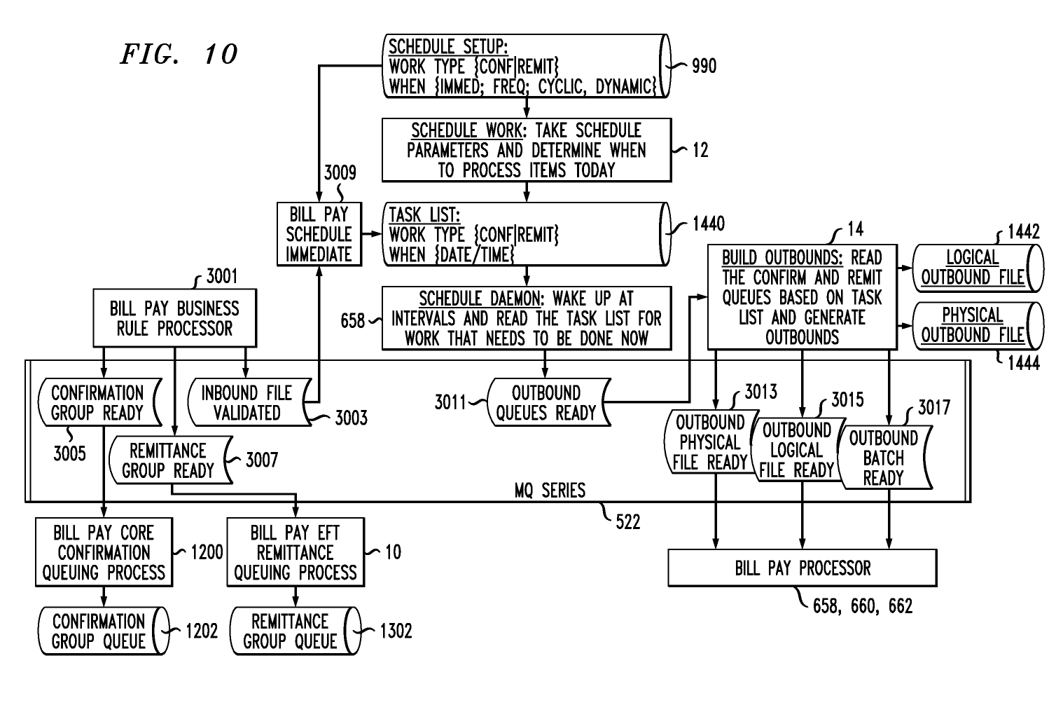

With regard to confirmation and remittance outbound file message design, in an exemplary embodiment, the message flow to the various bill payment components is as depicted in FIG. 10.

In one or more embodiments, when the business rule validation is complete at 3001, three messages are sent to the workflow:
Inbound file validated 3003—This message is a cue to a component of the work schedule to check whether any “immediate” processing is to be initiated as a result of the inbound file. The inbound file ID is preferably included in the message. The sending participant of the file may be profiled for an immediate confirmation file. Any of the participants represented by the inbound batches may also be profiled for immediate remittance.
Confirmation group ready 3005—This message tells the confirmation queuing processor that it may start generating confirmation group data. The inbound file ID is an example of significant data that should be included in the message.
Remittance group ready 3007—This message tells the remittance queuing processor 10 that it may start generating remittance group data. The inbound file ID is an example of significant data needed in the message.

These messages are delivered independently of each other, in some instances. The actions produced by the messages may run at the same time as other processes in the system as they are typically only dependent on data generated before the messages are delivered.

In one or more embodiments, the work schedule process 12 sends the following message when it has identified work that needs to be done “right now” (i.e., as per “bill payment schedule immediate” block 3009):
Outbound queues ready 3011—This message says that the task list has items with a status of “queued” and that all associated confirmation and remittance groups are ready to process for those items. The build outbound files processor 14 reads this message. All data needed to process this message is preferably contained in the task list table, so no application data needs to be embedded in the message.

In one or more embodiments, the process 14 that builds outbound files produces messages that the bill payment postprocessor uses to send the files to the participants. In some cases, three messages are sent.
Outbound physical file ready 3013—This message announces that a physical file is to be sent to one or more bill payment participants 502. The bill payment system should typically wait to send other messages about the file until a response is received for the corresponding physical file description message. Data in the message includes, for example:
   Number of logical files to be sent to the post processor to be packaged into a single physical file.
   ICA to receive the file
   End point to receive the file
   Bulk type to assign to the physical file.
Outbound logical file ready 3015—This message announces that a logical file is to be sent to a bill payment participant 502. The bill payment system should wait to send other messages about the logical file until a response is received for this message. Data in the message includes, for example:
   Number of batches to be sent to the post processor to be packaged into a single logical file.
   Reference to the physical file to contain the logical file.
   Attributes needed to populate the file header and control information for the logical file.
Outbound batch ready 3017—This message directs the bill payment post-processor to create summary or detail batches for the associated logical file. The bill payment system should wait to send confirmation batch messages until a response is received for the corresponding confirmation file message. The message parameters will include, for example:
   Reference to the associated logical file
   Outbound format to which the data must be converted before being sent to the end receiver.
   Sort order indicator giving the position within the logical file for the batch. Different format types typically require confirmation batches to appear before or after payment batches. This parameter allows the bill payment core system to communicate that order to the post-processor.
   Common format object containing data for the batch and transaction record fields.

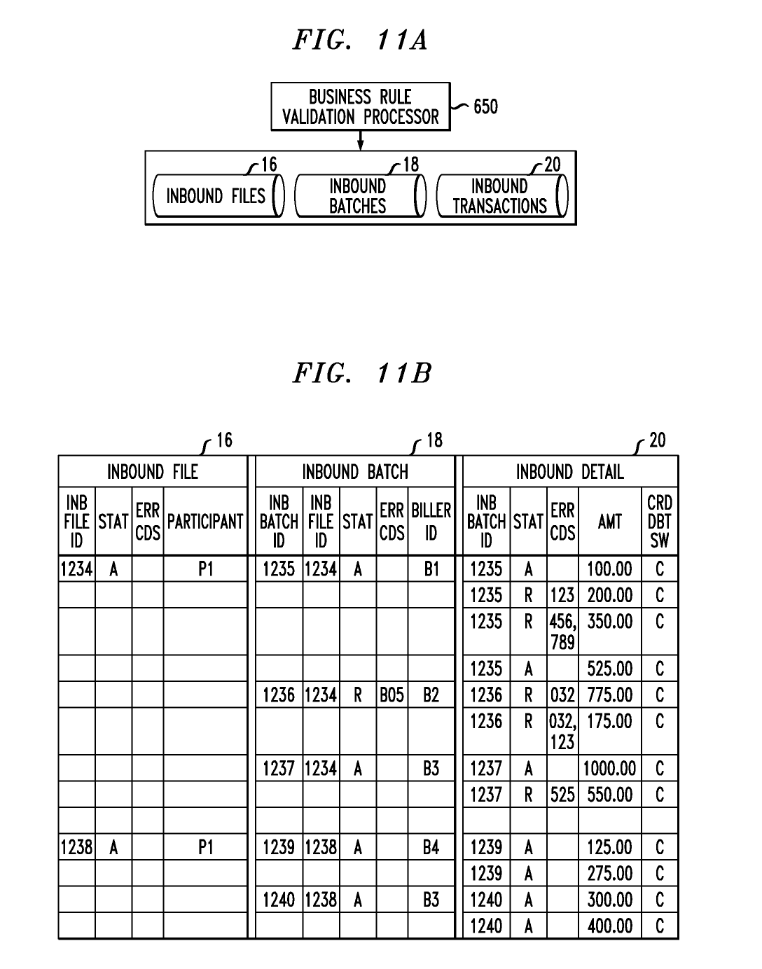

With reference to FIGS. 11A and 11B, in one or more embodiments, with regard to confirmation and remittance outbound file data design, when the inbound processing is completed in block 650, the participant-supplied data is stored in three primary tables 16, 18, and 20, corresponding to the logical files, the batches and the transaction details. From this inbound data, the confirmation process and the remittance process generate information that will eventually be out-bounded.

In one or more embodiments, the batch and detail tables have a status table associated with them to keep track of the data life cycle. Valid status settings are, for example:
Pending (values stored but not business rule validated)
Postponed (values stored but business rule validation on hold for maintenance window)
Validated (business rule validation complete—all error codes assigned)
Queued for confirmation (file and batch level)
Queued for remittance (batch level only)

The inbound detail table also preferably has a reference to the remittance group queue row associated with it. It is preferably null-able because it will typically not be populated until the remittance queuing process is run. This column may also be updated from the build outbound files process to adjust batches for batch limits or duplicate trace numbers.

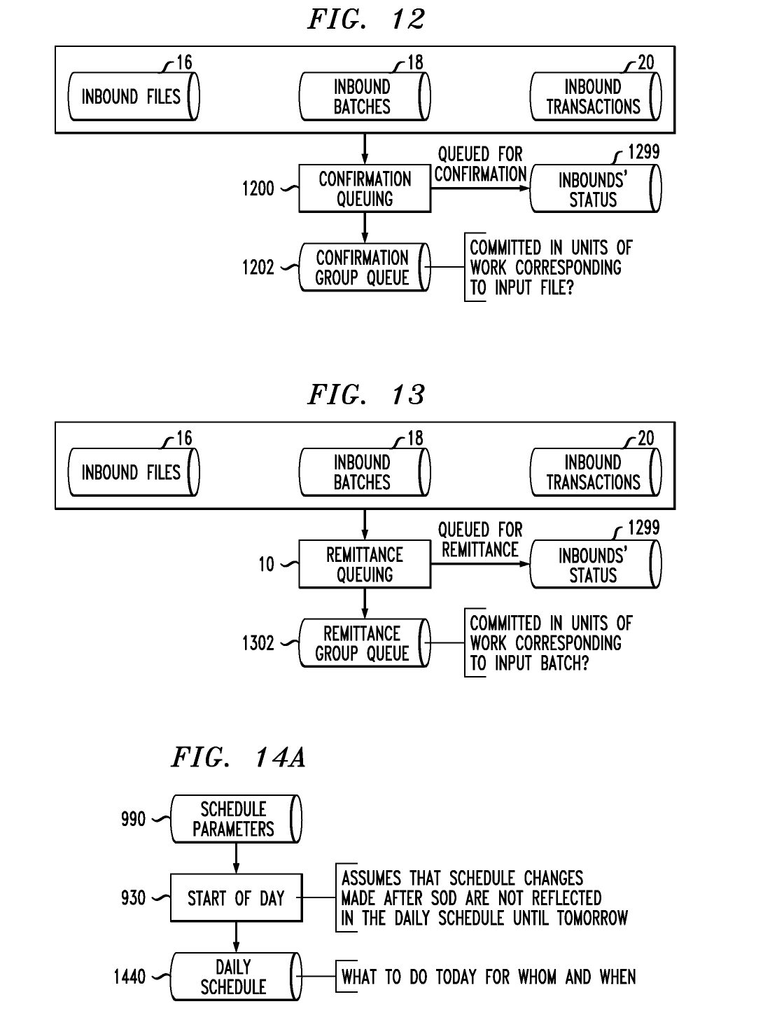

With regard to an exemplary confirmation queuing process 1200, refer to FIG. 12. This process organizes data that will eventually be output in the form of a confirmation file. The goal is to produce a set of confirmation groups (or batches) describing the transactions that were accepted and the ones rejected from the inbound file. This information is stored in the confirmation batches table. As per 1299, the inbound status is updated after queuing of the confirmation and remittance information are completed. In one or more embodiments, the following logic is executed:
If any transactions were accepted, a summary row is produced giving the number of transactions accepted and the total debit and credit amounts of those transactions.
If any transactions were rejected, a summary row is produced giving the number of transactions rejected and the total debit and credit amounts of those transactions.
If any inbound batches were rejected, a row is produced for each rejected batch giving the number of transactions in each batch and the total debit and credit amounts of those transactions.
If any detail transactions were rejected, a row is produced for each accepted inbound batch that contained one or more rejected details giving the number of rejected details and the total debit or credit amounts of those rejected transactions.

A sample depiction of the resulting table 1202 is given below.

Confirmation Group Queue

| | | | Dtl/ | | | Out- | |
|---|---|---|---|---|---|---|---|
| | Inbound | | Adden- | | | bound | Post- |
| Inbound | Batch | | da | Debit | Credit | Logical | Processor |
| File ID | ID | Type | Count | Amt | Amt | File ID | Work ID |
| 1234 | <null> | Sum | 3 | 0 | 1625.00 | | |
| | | Acpt | | | | | |
| 1234 | <null> | Sum | 5 | 0 | 2050.00 | | |
| | | Rej | | | | | |
| 1234 | 1236 | Batch | 2 | 0 | 950.00 | | |
| | | Rej | | | | | |
| 1234 | 1235 | Dtl | 2 | 0 | 550.00 | | |
| | | Rej | | | | | |
| 1234 | 1237 | Dtl | 1 | 0 | 550.00 | | |
| | | Rej | | | | | |
| 1236 | <null> | Sum | 4 | 0 | 1100.00 | | |
| | | Acpt | | | | | |

When the process is finished, this data is ready to be related back to the inbound tables to be able to produce confirmation out-bounds. For the inserted confirmation groups, the status of the associated rows in the inbound batch and inbound transactions are updated to “queued for confirmation.”

The outbound logical file ID and post-processor work ID columns will typically start out null. During the build outbound files process the columns will be assigned a value. These columns will allow the tracing of batches to the output confirmation files.

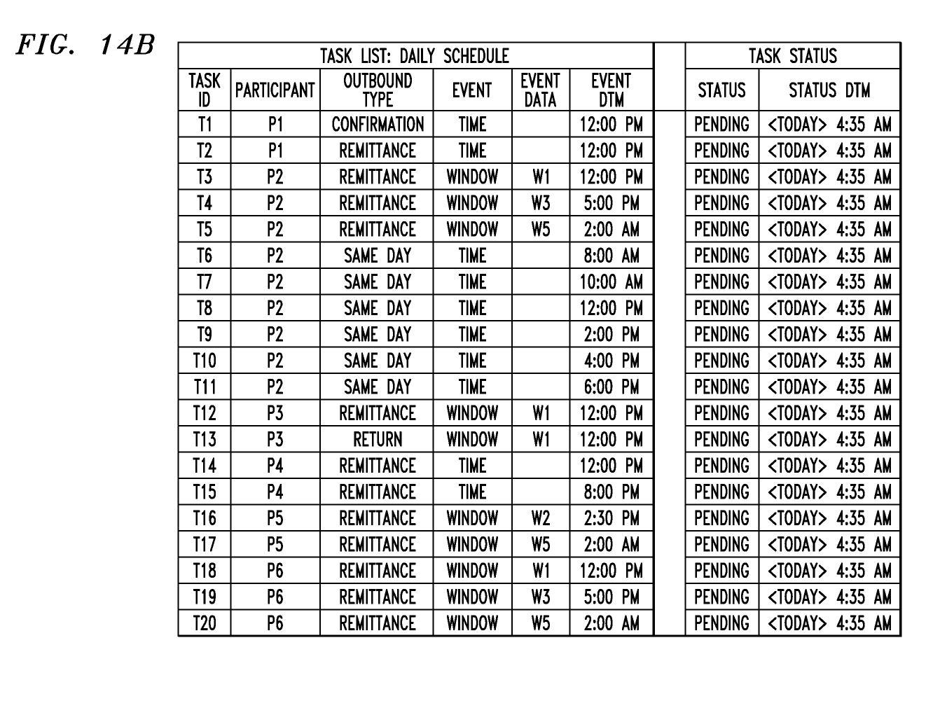

With regard to an exemplary remittance queuing process 10, refer to FIG. 13. This process organizes data that will eventually be output in the form of remittance payment details. The goal is to produce a set of remittance groups (or batches) describing the transactions that are to be forwarded to the billers through the concentrator. This information is stored in the remittance groups table by biller ID. In an example, the following logic is executed for each inbound batch of the file.
If the batch was accepted and one or more transactions were accepted, then generate a row containing the number of accepted transactions and the total debit or credit amount of the accepted transactions.

A sample depiction of the resulting table 1302 is shown below.

Remittance Group Queue

| Inbound | | | | | Outbound | Post- |
|---|---|---|---|---|---|---|
| Batch | Biller | Dtl/Addenda | Debit | Credit | Logical | Processor |
| ID | ID | Count | Amt | Amt | File ID | Work ID |
| 1235 | B1 | 2 | 0 | 625.00 | | |
| 1239 | B4 | 2 | 0 | 400.00 | | |
| 1236 | B2 | 0 | 0 | 0.00 | | |
| 1237 | B3 | 1 | 0 | 1000.00 | | |
| 1240 | B3 | 2 | 0 | 700.00 | | |

In one or more embodiments, when the process is finished, this data is ready to be related back to the inbound tables to be able to produce remittance out-bounds. For the inserted remittance groups the status of the associated rows in the inbound batch is updated to “queued for remittance.”

Note that during the building of the remittance outbound files, in one or more embodiments, rows in this queue destined for the same biller will be combined into a single outbound batch if the batch types are compatible.

The outbound logical file ID and post-processor work ID columns will typically start out null. During the build outbound files process the columns will be assigned a value. These columns will allow the tracing of transaction details to the output remittance files.

With regard to scheduler processes, in one or more embodiments, the schedule parameters table(s) 990 will hold the settings that each participant has chosen for receiving confirmation and remittance files. The bill payment system support staff will maintain these parameters along with the other parameter data. Each outbound type may have different schedule parameters from the following options, for example:
Immediate—the outbound process is initiated immediately after the inbound process is complete for each file.
Frequency—the outbound process is initiated at different times in the day specified as every so many minutes (or other time units) beginning at a certain time and continuing throughout the process day until another time (for example, every 2 hours beginning at 11:00 am and continuing through 8:00 pm)
Time of day—the outbound process is initiated at specific times of the day (for example at 12:00 pm, 5:00 pm and 8:00 pm)
Window—the outbound process is initiated at certain times throughout the processing day as set by the bill payment business team. This would simulate the current RPPS cycles, in a non-limiting example. Each participant would choose one or more windows in which to receive out-bound files.

Sample data depicting schedule parameters is given below.

Schedule Parameters

| Partici- | | Schedule | | | Start | End | |
|---|---|---|---|---|---|---|---|
| pant | Work Type | Type | Data | Minutes | Time | Time | Time |
| P1 | Outbound | Frequency | | 120 | 12:00 | 8:00 | |
| | | | | | PM | PM | |
| P2 | Remittance | Window | W1, | | | | |
| | | | W3, | | | | |
| | | | W5 | | | | |
| P2 | Same Day | Frequency | | 120 | 8:00 | 6:00 | |
| | | | | | AM | PM | |
| P3 | Remittance | Window | W1 | | | | |
| P4 | Remittance | Time | | | | | 12:00 |
| | | | | | | | pm, |
| | | | | | | | 8 pm |
| P5 | Remittance | Window | W2, | | | | |
| | | | W5 | | | | |
| P6 | Confirmation | Immediate | | | | | |
| P6 | Remittance | Window | W1, | | | | |
| | | | W3, | | | | |
| | | | W5 | | | | |

In some instances, the following configuration tables are employed in association with the schedule table:

Work Categories

| Work Type | Category |
|---|---|
| Outbound | <null> |
| Confirmation | Outbound |
| Remittance | Outbound |
| Payment | Remittance |
| Exception | Remittance |
| Same Day | Remittance |
| Credit Counseling | Remittance |
| Returns | Remittance |
| Reversal | Remittance |

In one or more embodiments, the work categories table defines the grouping and granularity of the configurable outbound types. In the sample data all types can be addressed by the term “Outbound.” “Remittance” is further divided into five other types.

Processing Windows

| Window ID | Start Time |
|---|---|
| W1 | 12:00 PM |
| W2 | 2:30 PM |
| W3 | 5:00 PM |
| W4 | 8:00 PM |
| W5 | 2:00 AM |

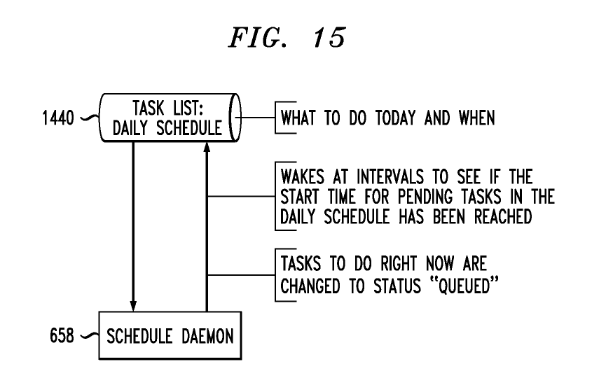

Referring to FIG. 14A, in a non-limiting example, the start of day process 930 produces a daily schedule 1440. At the start of each processing day a process is run that creates the daily schedule from these parameters 990. The schedule sets forth what to do today, for whom, and when.

Sample data depicting the daily schedule is given in FIG. 14B.

In some cases, the overall schedule for the current day is generated just once during start of day processing. However, items that are set up as “immediate” typically cannot be added to the schedule until the associated inbound files actually arrive. Throughout the processing day rows for the “immediate” items will be added as a time event with the current time as the event DTM. For example:

| Task List: Daily Schedule | | | | | | | |
|---|---|---|---|---|---|---|---|
| | | Out- | | | | Task Status | |
| Task | Partici- | bound | | Event | Event | | Status |
| ID | pant | Type | Event | Data | DTM | Status | DTM |
| T21 | P6 | Confir- | Time | | 10:45 AM | Pending | <today> |
| | | mation | | | | | 10:45 AM |

If dynamic scheduling of remittance is needed, those items are also inserted into the daily schedule table with similar settings.

In one or more embodiments, the valid status settings in the task list are:
Pending—the initial status of each task
Queued—queued for processing “right now.” The schedule daemon has identified the task as ready to start.
Started—the task is in progress now. The build outbound process has started gathering the transaction details associated with the task.
Completed—the task is complete. The build outbound process has generated the logical and physical file information and forwarded the outbound to the bill payment post-processor.

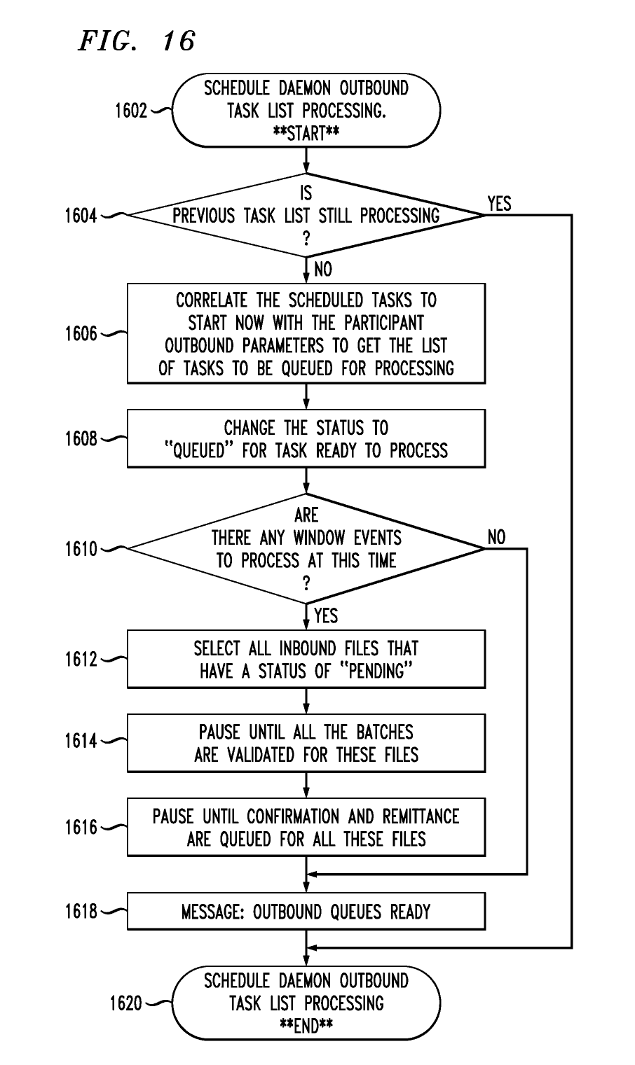

Referring to FIG. 15, one or more embodiments employ a schedule daemon process 658 which lists tasks to be done “Right Now.” At regular intervals, a schedule daemon process will compare the time of day with the pending items in the daily schedule 1440 to see if any action needs to be taken. If items are found, a number of configuration tables are consulted to control the generation of a task priority list.

The items in the task list table with the status “queued” are those to be done “right now.” For outbound processing, it lists the items by participant, work type, destination end point and bulk type. To facilitate the list creation, the following configuration tables are utilized in one or more embodiments.

The list of queued tasks is joined to the following configuration tables to enable the building of outbound files.

Outbound Default Bulk Type (Content)

| | | Format | |
|---|---|---|---|
| Outbound Type | Format Type | Version | Bulk Type |
| Outbound | MOD-CIE | 1.0 | B0 |
| Confirmation | MOD-CIE | 1.0 | B1 |
| Payment | MOD-CIE | 1.0 | B2 |
| Exception | MOD-CIE | 1.0 | B3 |
| Same Day | MOD-CIE | 1.0 | B4 |
| Credit Counseling | MOD-CIE | 1.0 | B5 |
| Returns | MOD-CIE | 1.0 | B6 |
| Outbound | ACH-CIE | 1.0 | B0 |
| Confirmation | ACH -CIE | 1.0 | B1 |
| Payment | ACH -CIE | 1.0 | B2 |
| Exception | ACH -CIE | 1.0 | B3 |
| Same Day | ACH -CIE | 1.0 | B4 |
| Credit Counseling | ACH -CIE | 1.0 | B5 |
| Returns | ACH -CIE | 1.0 | B6 |

The outbound default bulk type table gives the default bulk type defined for each outbound type. Participants may elect to send some outbound types to a different bulk type for easier identification.

Participant Outbound Content Setup

| Participant | Outbound Type | Bulk Type Override Switch | End Point |
|---|---|---|---|
| P1 | Outbound | N | E1 |
| P2 | Outbound | N | E2B |
| P2 | Same Day | N | E2A |
| P3 | Outbound | N | E3 |
| P3 | Returns | Y | E3 |
| P4 | Outbound | N | E4 |
| P5 | Outbound | N | E5 |

The participant outbound parameters record the choices the participant has made regarding delivery destination options. The main entry giving the default bulk type and end point designations are given as outbound type “Outbound,” the most general type in the hierarchy. Overrides for sub-categories indicate a different destination for the specific category. Participants can choose different bulk type and/or end point for any outbound type. In the sample data:
Participant P2 has elected to receive all outbound files as bulk type B0 at end point E2B with the exception that any same day payments are to be received at end point E2A (as bulk type B0).
Participant P3 has elected to receive all outbound files as bulk type B0 at end point E3 with the exception that any returns are to be received as bulk type B6 at the same end point, E3.

These configuration tables then allow the schedule daemon to produce the list of tasks ready to perform now for the outbound process. The following sample data can be produced by combining the tables. Note that in one or more embodiments, the following sample is a virtual table produced by the program code; there is no physical table in the database corresponding to it. Other embodiments could take a different approach.

| Task List - Things To Do Right Now | | | | | | | | |
|---|---|---|---|---|---|---|---|---|
| | | Par- | | | | Task Status | | |
| Task | | tici- | Bulk | End | Work | Task | | |
| ID | ICA | pant | Type | Point | Type | ID | Status | Time |
| T1 | I1 | P1 | B0 | E1 | Confir- | T1 | Pending | 12:02 PM |
| | | | | | mation | | | |
| T2 | I1 | P1 | B0 | E1 | Remit- | T2 | Pending | 12:02 PM |
| | | | | | tance | | | |
| T3 | I2 | P2 | B0 | E2B | Remit- | T3 | Pending | 12:02 PM |
| | | | | | tance | | | |
| T4 | I2 | P2 | B0 | E2A | Same | T4 | Pending | 12:02 PM |
| | | | | | day | | | |
| T5 | I3 | P3 | B0 | E3 | Remit- | T5 | Pending | 12:02 PM |
| | | | | | tance | | | |
| T6 | I3 | P3 | B6 | E3 | Return | T6 | Pending | 12:02 PM |
| T7 | I1 | P4 | B0 | E4 | Remit- | T7 | Pending | 12:02 PM |
| | | | | | tance | | | |

In the sample data, the tasks to be done now are:
Outbound a confirmation file for participant P1 using bulk type B0 to end point E1
Outbound a remittance file for participant P1 using bulk type B0 to end point E1
Outbound a remittance file for participant P2 using bulk type B0 to end point E2B and the like.

Note that in the virtual task list, each unique combination of ICA (Interbank Card Association number), bulk type and end point is a unique outbound physical file.

In one or more embodiments, valid values in the task status table are:
Pending
Started (or queued)
Complete

If the schedule daemon starts its processing at the end of day, an additional sweep will be made to ensure that there are no tasks left over for the start of the next day. The sweep should consider the following:
Any pending content in the confirmation group queue should have a corresponding task with the status of pending.
Any pending content in the remittance group queue should have a corresponding task with the status of pending.

The final step of the daemon execution is to produce a message to start the building of the outbound files. The timing of this message is straight forward if the task list is produced only from “Time” events in the daily schedule. However, in some instances, special processing is needed when “Window” events are involved.

When the time arrives for window processing, the system must typically delay the building of the outbound files to give the system time to finish the inbound process for any data already received. To do this, a list of files that have been received but not queued for confirmation or remittance is produced. The starting of the outbound building process is delayed until all batches for those files have been received and until all details in those files have been queued for confirmation and remittance.

The task list may, in some cases, be built before all inbounds are queued; it is dependent only on the schedule and configuration tables. However, if the task list is built before all the inbounds are queued, files received in the meantime (during the delay) to be confirmed or remitted in the “immediate” mode will wait until the next task list is built.

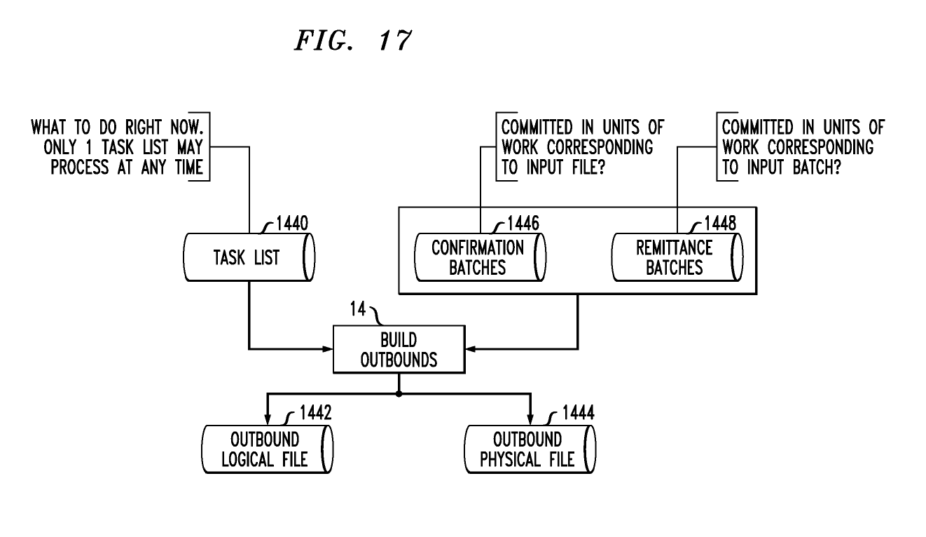

FIG. 16 shows exemplary task list initiation when window events are present. Processing begins at 1602. In decision block 1604, determine whether the previous task list is still processing. If not, as per the “NO” branch, proceed to step 1606 and correlate the scheduled tasks to start now with the participant outbound parameters to get the list of tasks to be queued for processing. Then, in step 1608, change the status to “queued” for tasks that are ready to process, and proceed to decision block 1610. In block 1610, determine whether there are any window events to process at this time. If not, as per the “NO” branch, send a message that outbound queues are ready, in step 1618, and proceed to end step 1620. Note that if, in decision block 1604, it was determined that the previous task list was still processing (“YES” branch), then processing proceeds directly to end block 1620.

If decision block 1610 yields a “YES,” then proceed to step 1612 and select all inbound files that have a status of “pending.” Then, in step 1614, pause until all the batches are validated for these files. Further, in step 1616, pause until confirmation and remittances are queued for all the files in questions, and proceed to step 1618.

In an alternative approach for delaying the start of processing at a window, send a message to the pre-processor to send back: a list of files queued for processing, their size, and the time they arrived from GFT. For all files that arrived by the cutoff time and (optionally) are under a certain size, wait until their confirmation and remittance groups are complete.

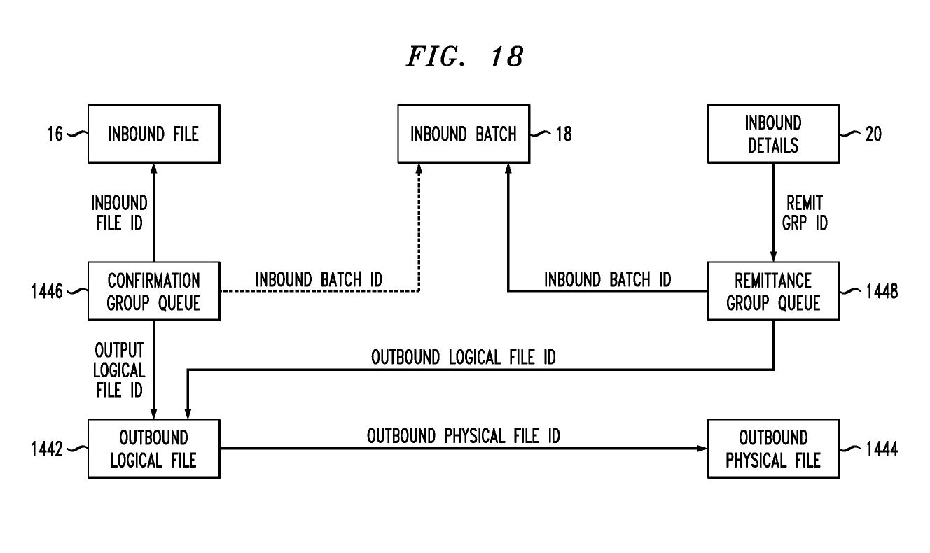

Reference should now be had to FIG. 17 in connection with an exemplary build outbound files process. When the task list 1440 is generated and the confirmation queue 1446 and remittance queue 1448 are ready, the building of the outbound files (logical 1442 and physical 1444) may begin. This process takes all the confirmation and remittance batches 1446, 1448 associated with each task in the list and produces messages to the post processor to generate the outbound files, as per “build outbounds” block 14.

In one or more embodiments, the following configuration tables are employed to help this process (some exemplary participant parameters).

Participant

| | | | | |
|---|---|---|---|---|
| | | | Confirmation | |
| Participant | Outbound Format | No Data Style | Style Code | . . . |

| | | | |
|---|---|---|---|
| P1 | MOD-CIE | None | ◯ |
| P2 | ACH-CIE | None | ◯ |
| P3 | MOD-CIE | None | ◯ |
| P4 | ACH-CIE, ACH-CTX | EmptyFile | ◯ |
| P5 | MOD-CIE | None | ◯ |

The exemplary participant table holds parameters for each participant. Some of those parameters are shown here as a non-limiting example. The outbound format type tells the formats the participant may use for outbound files. The no data style tells whether a “no data file” is to be sent to the participant if no detail transactions are received for them on a window that they have chosen. The no data style may have the values:
None
Empty
ZeroCount

The confirmation style code tells what level of detail is to be included in confirmation files for this participant. The values are:
‘O’ indicating the original RPPS style (again, references to RPPS are exemplary and non-limiting. In other embodiments, for example, a similar code could be provided to indicate some other style, such as a style of a legacy system).
‘F’ indicating a comma delimited confirmation file showing all input records.
‘R’ indicating a comma delimited confirmation file showing only rejected records.
‘M’ indicating the confirmation file that will be accessed through MOL and is not to be automatically sent by the bill payment system.

The below table presents exemplary configuration data for the outbound file Structure:

Outbound Configuration

| | | Outbound | Logical file | |
|---|---|---|---|---|
| Config ID | Dest Format | Type | ID | Order |
| C1 | MOD-CIE | Reversal | L1 | 6 |
| C1 | MOD-CIE | Payment | L1 | 3 |
| C1 | MOD-CIE | Exception | L1 | 5 |
| C1 | MOD-CIE | Same Day | L1 | 2 |
| C1 | MOD-CIE | Credit | L1 | 7 |
| | | Counseling | | |
| C1 | MOD-CIE | Returns | L1 | 4 |
| C1 | MOD-CIE | Confirmation | L2 | 1 |
| C2 | ACH-CIE | Reversal | L3 | 5 |
| C2 | ACH-CIE | Payment | L3 | 2 |
| C2 | ACH-CIE | Exception | L3 | 4 |
| C2 | ACH-CIE | Same Day | L3 | 1 |
| C2 | ACH-CIE | Credit | L3 | 6 |
| | | Counseling | | |
| C2 | ACH-CIE | Returns | L3 | 3 |
| C2 | ACH-CIE | Confirmation | L4 | 7 |

The outbound file structure configuration tells which outbound types can be grouped together in the same logical files and what order those types are to appear in the file.

The below table presents exemplary Outbound Physical File data:

Physical Outbound File

| Outbound File ID | Outbound File Date Stamp | ICA |
|---|---|---|
| 2000 | 6/11/2008 11:46 | P1 |
| 2001 | 6/11/2008 12:02 | P2 |
| 2002 | 6/11/2008 12:02 | P2 |
| 2003 | 6/11/2008 12:02 | P3 |
| 2004 | 6/11/2008 12:02 | P3 |
| 2005 | 6/11/2008 12:02 | P4 |

The above table contains the description of the physical files to be outbound. There is one row for each physical file. The outbound file ID is a sequence number. This ID is put back into the confirmation queue and remittance queue tables showing which groups are associated with which physical file. As noted above, each unique combination of ICA, bulk type and end point in the task list table represents a distinct outbound physical file. The rows in this table are generated by querying the task list.

The below table presents exemplary outbound logical file data:

Logical Output File

| | | | | | | | |
|---|---|---|---|---|---|---|---|
| | | Out- | Physical | | | | |
| | Par- | bound | Out- | File ID | | | Dtl/ |
| Logical | tici- | Config | bound | Modi- | Debit | Credit | Addenda |
| File ID | pant | ID | File ID | fier | Amt | Amt | Count |

| | | | | |
|---|---|---|---|---|
| LF1 | P1 | C1 | 2000 | 1 |
| LF2 | P1 | C2 | 2000 | 2 |
| LF3 | P2 | C3 | 2001 | 1 |
| LF4 | P2 | C3 | 2002 | 2 |
| LF5 | P3 | C1 | 2003 | 1 |
| LF6 | P3 | C1 | 2004 | 2 |
| LF7 | P4 | C3 | 2005 | 1 |

This table lists all the logical files containing outbound information. It is built by correlating the task list table with the outbound file configuration table. The following are combined to tell whether the confirmation and remittance groups can be combined into a single logical file or whether multiple logical files are needed:
The participant in the confirmation queue and remittance queue tables
The outbound format of the participant from the outbound configuration table
The outbound type from the confirmation queue and remittance queue table

Each logical file may combine one or more confirmation and remittance groups.

After the content is placed in the two outbound file tables, messages to the bill payment post-processor are generated to guide the creation of the actual outbound files.

This process preferably also addresses:
File ID Modifier This logical file attribute is used by the MOD-CIE (Modified customer initiated entry) and ACH-CIE (Automated Clearing House customer initiated entry) formats to give a unique modifier for each file from a single participant in a single calendar day.
Batch Limit—Each biller is allowed to set a limit on the maximum accumulated net amounts within any batch sent to them. The build outbound file process must take this limit into consideration when combining transaction details into batches from the remittance group queue.
Duplicate Trace Numbers—Within a MOD-CIE or ACH-CIE batch, trace numbers must be ascending and must be unique. If multiple inbound files are received in a day it is possible that duplicate trace numbers may be present. Any duplicate trace numbers must be put in separate batches.
No Data File—Participants may elect to receive a “no data” file for windows, frequencies or times in which they receive no remittance data. This process must detect that and provide the “no data” files if requested.

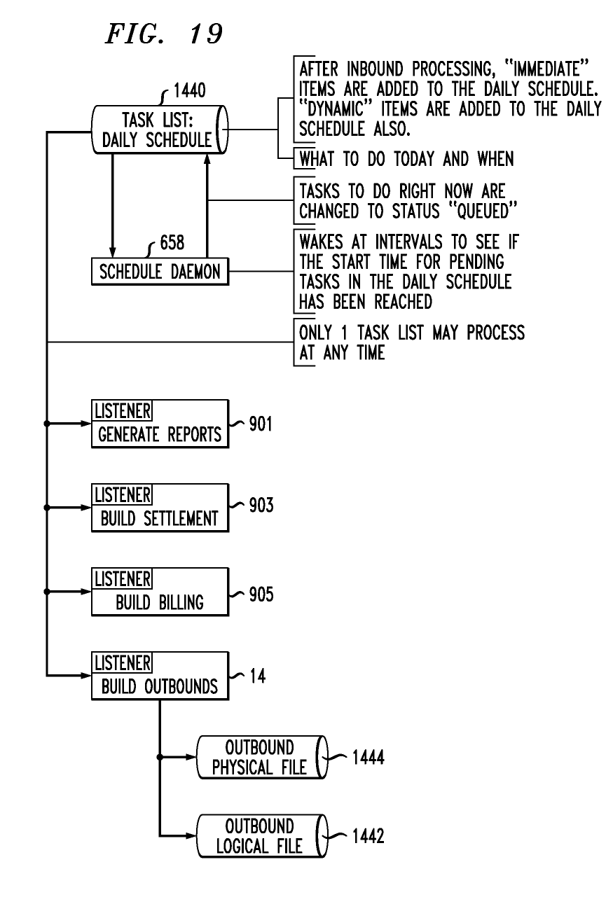

FIG. 18 shows how the various previously-described inbound and outbound tables are linked together in one or more embodiments. These mappings allow tracing from/to inbound detail to/from physical remittance files and also from/to inbound batches to/from physical confirmation files.

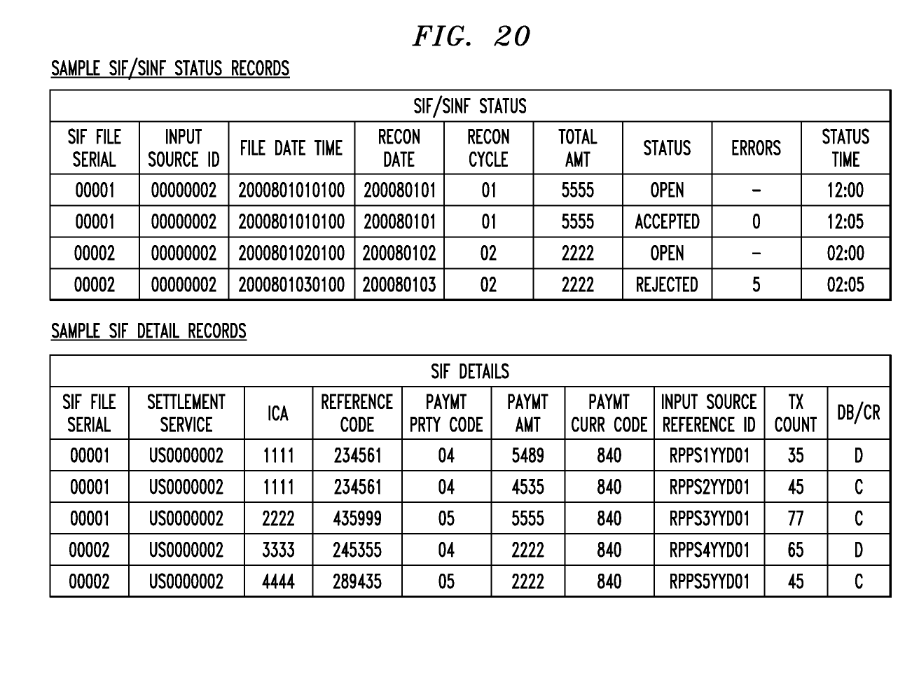

FIG. 19 depicts an exemplary settlement process with bill payment outbound data flow. As a part of the start of day processing, the daily schedule 1440 is generated based on the scheduled parameters. This daily schedule also includes the details for the creation of the settlement files (SIF). In some instances, the SIF files will be created only during the window event. For all the “Remittance outbound” type, a separate entry will be created for the settlement process. During the window time frame, after completion of the remittance processing, the schedule daemon 658 will start the settlement process which will create the SIF files. The SIF files will be generated in parallel to the creation of the outbound files.

In one or more embodiments, the remittance group queue table will be the driver table for the SIF creation process. An example of sample remit group data follows:

Remittance group queue

| | | | | | | |
|---|---|---|---|---|---|---|
| | | Dtl/ | | | Outbound | Post- |
| Inbound | Biller | Addenda | Debit | Credit | Logical File | Processor |
| Batch ID | ID | Count | Amt | Amt | ID | Work ID |

| | | | | |
|---|---|---|---|---|
| 1235 | B1 | 2 | 0 | 625.00 |
| 1239 | B4 | 2 | 0 | 400.00 |
| 1236 | B2 | 0 | 0 | 0.00 |
| 1237 | B3 | 1 | 0 | 1000.00 |
| 1240 | B3 | 2 | 0 | 700.00 |

For the SIF version 3, the payment party account reference code is a mandatory field. This field can be obtained from the MPS (Members Parameter System) parameter system. This is unique for the settlement service—payment party combination. This field is profiled in the SAM (Settlement Account Management) profile system and propagated to the MPS parameter system. Of course, throughout this exemplary embodiment, items which are mandatory may be optional in other embodiments.

The MPS tables which will be accessed are as follows. A DB2® connection (registered mark of International Business Machines Corporation) to the MPS tables can be established from the bill payment database, for example.
TGPABUD—business partner name—business partner table
TGPAMSD—settlement service info—input sources associated with member assignment
TGPAXBD—transfer agent ID—transfer agent assignments

The logical details of the originator/concentrator values are summarized as follows (table for direction code):

Originator/Concentrator

| | Originator | | | | | |
|---|---|---|---|---|---|---|
| | Debit/ | | | Concentrator | | |
| | credit | Direction | Type | Debit/Credit | Direction | Type |
| | Code | Code | Code | Code | Code | Code |
| Payments | D | S | 04 | C | R | 05 |
| Returns | C | R | 05 | D | S | 04 |
| Reversals | C | S | 04 | D | R | 05 |
| Return | D | R | 05 | C | S | 04 |
| Reversals | | | | | | |

In a non-limiting example, payment party type code “04” always goes with direction code “S,” and payment party type code “05” always goes with direction code “R.” It is dependent on who is sending or receiving the actual transactions. Debit credit code is dependent on the direction of the funds. For example for all the payment transactions, it is a debit for originator and a credit for the concentrators. For payment transactions, the originator is the sender so the direction code is ° S′ and the concentrator is the receiver of the funds, hence the direction code is ‘R.’

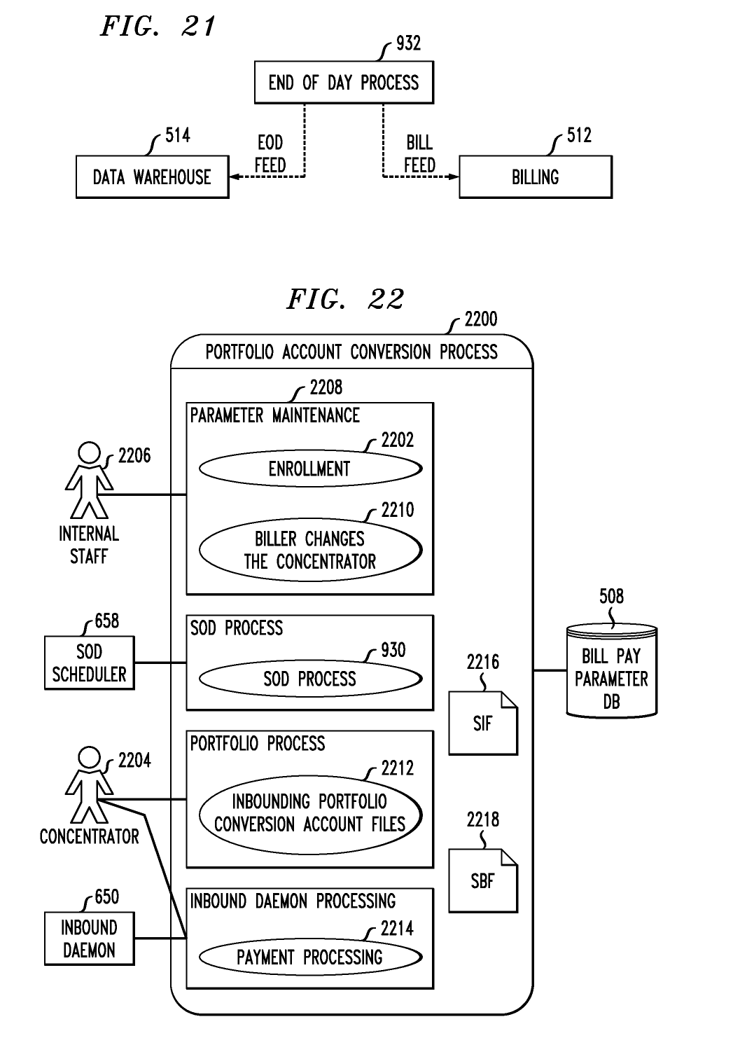

During the SIF process, a record is inserted in the SIF status table corresponding to a single SIF file. The SIF file serial number is a unique number assigned to each of the physical SIF files. It is a sequential count of each file starting at 1 and rolling over to 1 after reaching 99999. This feature can be used to track individual files. This file serial number is also used during the Settlement Notification (SINF) process to identify the status of the file. Furthermore, in one or more embodiments, the relevant SIF details are created in the SIF detail table. This table can be used to generate settlement reports in the future. Refer to the two tables of FIG. 20 for more details.

In one or more embodiments, the SIF files will be transmitted to the SAM system using an internal GFT bulk type. Since GFT already stores the files by default, the physical files will not be stored in the bill payment system. Other embodiments may take a different approach.

After processing the SIF file, the SAM system will generate the corresponding Settlement Notification (SINF) files. The SINF file will be transmitted to the bill payment system using internal bulk type in GFT. A new TWS (Tivoli Workload Scheduler) job will be created which will be triggered on the arrival of the SINF file in the specified directory location. The SINF files will be processed by the bill payment system looking for the return status. The status will be stored and if there are errors then a FATAL error will be logged and notification will be generated for immediate attention by the bill payment system support team, using, for example, IBM Tivoli® software (registered mark of International Business Machines Corporation). Again, other approaches may be used in different embodiments.

The retention of data in the SIF tables can be decided based on appropriate considerations.

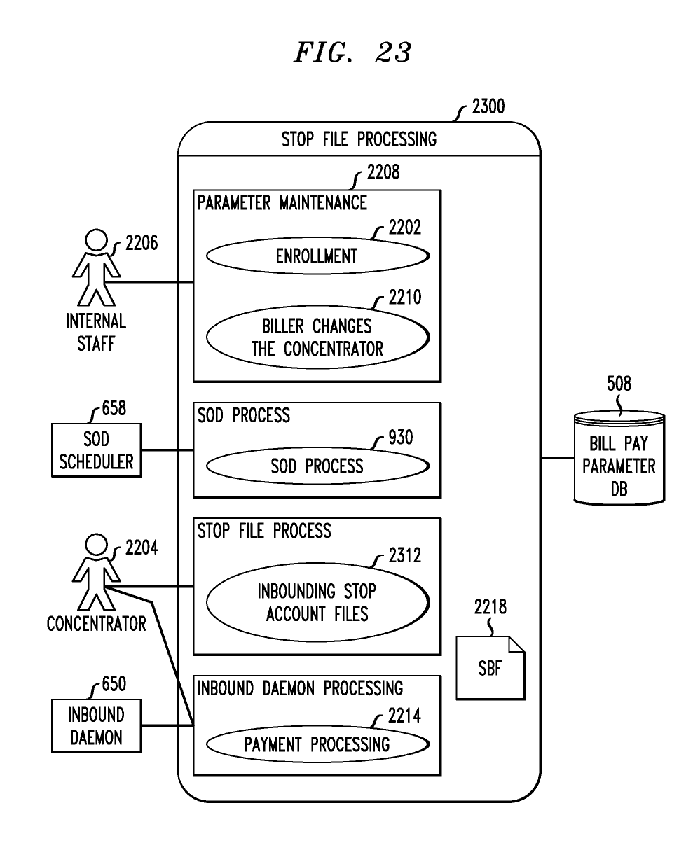

An exemplary end of day process 932 will now be described with respect to FIG. 21. In some instances, this will be done after the completion of processing of the 5^{th} window. In this particular example, the following steps needs to be done as a part of the end of day process:
Any records which are in the confirmation and remittance queue which were not processed must be processed and the corresponding confirmation/remittance files must be created. The files cannot be held for the next day processing.
The system will generate No-Data file for the participants who were profiled to receive and did not get any transactions for the current day.
Some of the staging tables must be purged and cleaned before the start of the day processing begins.
As a part of the process, a feed needs to be generated for the data warehouse 514.
A billing feed 512 will be generated and delivered to the billing application.
At the completion of the End of day process, the parameter maintenance window begins and continues till the start of the day process begins.

The following table shows the mapping of the Data warehouse fields and the corresponding bill payment tables which contains the data.

| Data Warehouse Field | Bill payment Table |
|---|---|
| Sending RPPS ID | Inbound file |
| Sending RPPS IDName | Participant setup |
| Consolidator Name | Consolidator setup |
| Contact Name | Participant setup |
| Telephone Number | Participant setup |
| Fax Number | Participant setup |
| Email address | Participant setup |
| Receiving RPPS ID | Participant setup |
| Original Biller ID (True) | Inbound file |
| Alias Biller ID | Same as Original Biller |
| | ID (True) for phase 1 |
| Converted Biller ID | Same as Original Biller |
| | ID (True) for phase 1 |
| Merchant Name | Biller setup |
| Concentrator Name | Participant setup |
| Contact Name | Participant setup |
| Telephone Number | Participant setup |
| Fax Number | Participant setup |
| Email Address | Participant setup |
| Converted Biller Id | Same as Original Biller |
| | ID (True) for phase 1 |
| Date file processed inbound | Inbound file status |
| Time file processed inbound | Inbound file status |
| Date file processed outbound | Physical outbound file |
| Time file processed outbound | Physical outbound file |
| Tran code | Inbound detail |
| Tran status | Inbound detail |
| Original Account number | Inbound detail |
| Converted Account Number | Same as Original Account |
| | number for phase 1 |
| Customer Name | Participant setup |
| Error Code(s) | Inbound file error, |
| | Inbound batch error |
| Amount of transaction | Inbound detail |
| Trace number | Inbound detail |
| File control information | Inbound file |
| (file debit, credit amounts) | |
| Encrypted Trace Number | Inbound detail |
| Batch control information | Inbound batch |
| Error status | Inbound file error |
| ICA | Participant setup |
| Currency Code | Inbound detail, Inbound |
| | batch, Inbound file |
| Product Code | Participant setup |
| Business Code | Participant setup |

In some instances, the billing process is kicked off as a part of the end of the day processing. For the specified day of processing, the billing process will accumulate all the details required for the creation of the billing files.

The billing process will create the following files and deliver them to a suitable billing system application, such as the MCBS (MasterCard Billing System) application.
a) Sender Billing—For all accepted transactions, billing data details for the sending ICA/RPPS ID
b) Receiver Billing—For all accepted transactions, billing data details for the receiving ICA/RPPS
c) Reject billing—For all rejected transactions, billing data details for the sending ICA/RPPS ID.
d) Audit—Contains summary of the sending/receiving/reject billing files.

The inbound detail table contains all the necessary data related to the accepted and rejected detail records. The billing process will get all the transaction records for the given processing day from the inbound detail table, ICA/RPPS ID information from the related tables, and generate the physical billing files. At the end of the processing it will update the inbound file status table with the completion of the billing status. The physical billing files will not be stored in the bill payment system. These files will be accessible from the GFT for the internal users. Other approaches could be used in other embodiments.

### VRU (Voice Response Unit) Design

In some instances, one or more embodiments will replace or supplement an existing system. Purely by way of example and not limitation, in some such cases, only a VRU summary table will be populated and VRU maintenance information will be copied from a current (e.g., legacy) VRU contacts table. In some cases, one or more embodiments do not involve the addition of new members; in such cases, there may not be any anticipated changes for VRU maintenance. An interface for maintaining members may be covered in the internal tools requirements. A “PHONE” table may contain a phone type indicating VRU.

In some cases, such as, for example, a transition process, a new VRU summary table can be compared to an existing one, but not actually be used as the data source to perform the VRU calls. Later, when the table will start to be used to perform the actual VRU calls, the ‘call completed’ switch on all the existing records can be set to ‘Y’ first.

In a non-limiting example, a process for verifying that the voice response unit (VRU) calls have been completed can be performed by a Perl script that is kicked off on a specific schedule. If there is no information from the prior day's processing cycles, or if calls have not been completed for any information from the prior day's processing cycle, then the system will send an alert e-mail to the RPPS help desk and to RPPS account support. If the calls actually failed, Account Support will manually make the calls and update the VRU Summary table via the customer service representative (CSR) Tool.

With regard to reversal processing, one or more embodiments allow RPPS originators to reverse any payment transactions that were sent to RPPS (concentrators and/or billers) erroneously, such as duplicate payment submitted by the consumers, duplicate file being sent by the originator, and the like.

With regard to return payment & return reversal processing, one or more embodiments allow an RPPS concentrator and/or biller to return any payment transactions or reversal transactions to the originators due to an un-postable situation on the biller's side. This may be due to the account number being closed, incorrect, or the like.

With regard to non financial transaction processing, one or more embodiments allow both the RPPS originator and RPPS concentrator and/or biller to exchange non payment transaction information that may require action on the receiving side, such as an account number change.

Again, purely by way of a non-limiting example of transitioning from a legacy system to a system employing one or more aspects of the invention, during an initial part of the transition, data views or feeds from the bill payment (e.g., new application) tables will be created. These will be used to manually compare existing legacy system data to the corresponding bill payment data. In future phases of the transition, the bill payment views or feeds will replace the current methods of populating RPPS or similar data warehouse tables.

In one or more embodiments, concentrators can create returns using the payments center for their billers or they can give their billers access to the return functionality in the payments center. An issue in some circumstances is that there is no easy way for the concentrator to be able to identify which returns were created by a biller and then be able to charge back the biller for their returns. This is a reconciliation issue that is a barrier to many concentrators giving their billers the convenience of self-service via the returns functionality on the payments center. In some cases, the mainframe has the information required to create a report and/or a file of required data to assist the concentrators in reconciling returns created by billers using the payments center. This information is accessed and a report and/or a file is created that can be sent to or accessed by the concentrator.

Currently, the returns information is rolled into high level confirmation totals in existing concentrator confirmation files. One or more embodiments provide an enhancement that allows the user to choose how he or she wishes to receive this information. In some cases, the user selects whether he or she wants to receive a high level summary or details on the returns information. For each selection, the user can choose the method of delivery. Examples regarding the delivery of information include:
Create a separate payments center return confirmation process; create a new file feed specific to returns from the payments center. This is an automated option and can be a billable option.
Incorporate the information into existing outbound files. This is an automated option and can be a billable option.
Query and/or report the information via the payments center and allow it to be exported.

Some instances allow a user to have view-only access to this information. This restricts editing and submitting of returns but allows querying and downloading of the information, based on the user's set-up. Concentrators who have billers who can use payments center to reconcile are an example of entities that may benefit from such functionality.

With regard to portfolio conversion, some embodiments allow RPPS participants (concentrators and/or billers) to convert account numbers due to acquisition of new portfolio(s) or migrating their account numbers. Refer, for example, to co-assigned U.S. Pat. No. 7,917,435 of Hall et al., entitled “Apparatus and method for facilitating account restructuring in an electronic bill payment system,” the complete disclosure of which is expressly incorporated herein by reference in its entirety for all purposes, and to co-assigned US Patent Publication 2010/0174644 of Rosano et al., entitled “Integrated File Structure Useful in Connection with Apparatus and Method for Facilitating Account Restructuring in an Electronic Bill Payment System,” the complete disclosure of which is also expressly incorporated herein by reference in its entirety for all purposes.

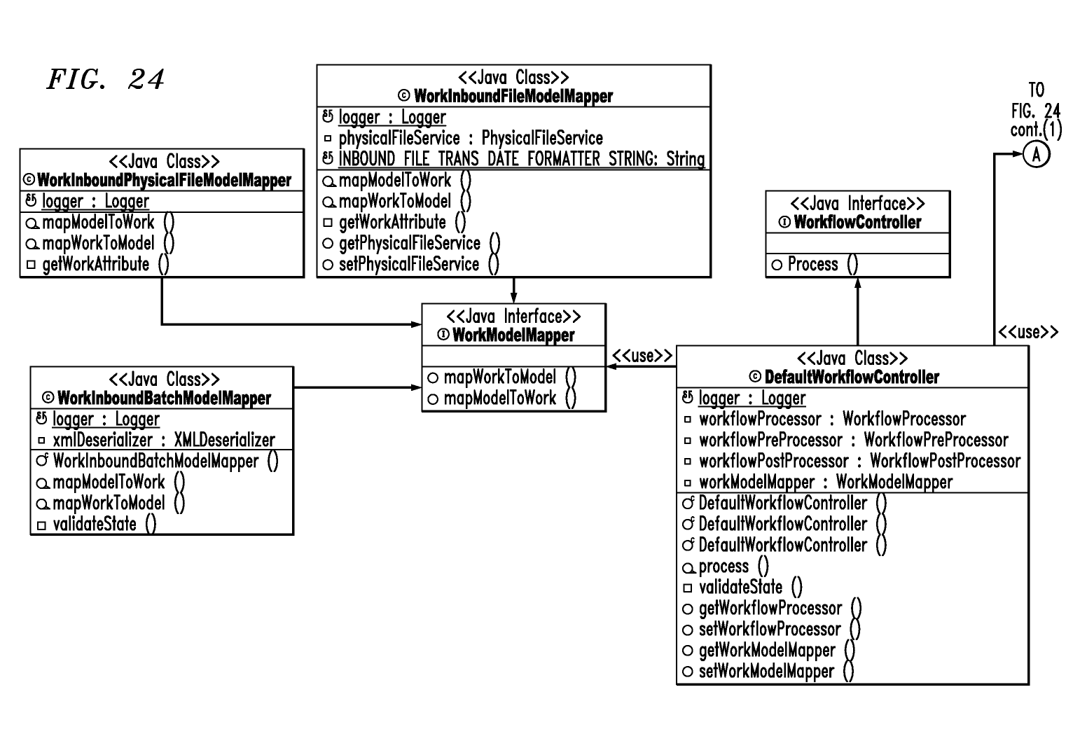

FIG. 22 presents a high level flow diagram for an exemplary portfolio conversion process 2200. During enrollment 2202, the concentrators 2204 and/or biller will provide the information to product support 2206 to register and/or enroll a biller for the service; this can be done, for example, in the parameter maintenance 2208.

Where the biller changes the concentrator, as at 2210, portfolio conversion is set up between the old biller and/or concentrator and new biller and/or concentrator, with a service payer that is either the old or new biller, and with a start date. In this process, if any of the information changes, then the existing relationship should preferably be inactivated and a new one should be set up.

In the SOD process 930, for all portfolio account conversion file registrations that have a start date of today, set the registration to active and for all portfolio account conversion file registrations that have an end date of today, set the registration to inactive.

In the portfolio account conversion process 2212, the details of portfolio account conversion files are validated and uploaded in the data base 508.

During the payment processing 2214, in some cases, apply additional business rule to the standard payment transaction to identify the concentrator(s) and/or biller(s) registered for portfolio account conversion. Element 2214 represents the payment processing techniques described elsewhere herein.

With regard to SIF 2216, in some cases, the SIF file creation process considers the RPPS ID/ICA details of the new biller and/or concentrator for converted transactions. With regard to SBF 2218 (Simple Billing Feed), in some cases, during the SBF process 2218, monthly fee, file upload fee, account upload fee and portfolio conversion transaction fee are maintained in bill payment at the biller enrollment level.

Note that useful information on portfolio conversion can be found in co-assigned US Patent Publications US 2008-0046364 A1 of Hall et al. and US 2010-0174644 A1 of Rosano et al., the complete disclosures of both of which are expressly incorporated herein by reference in their entireties for all purposes.

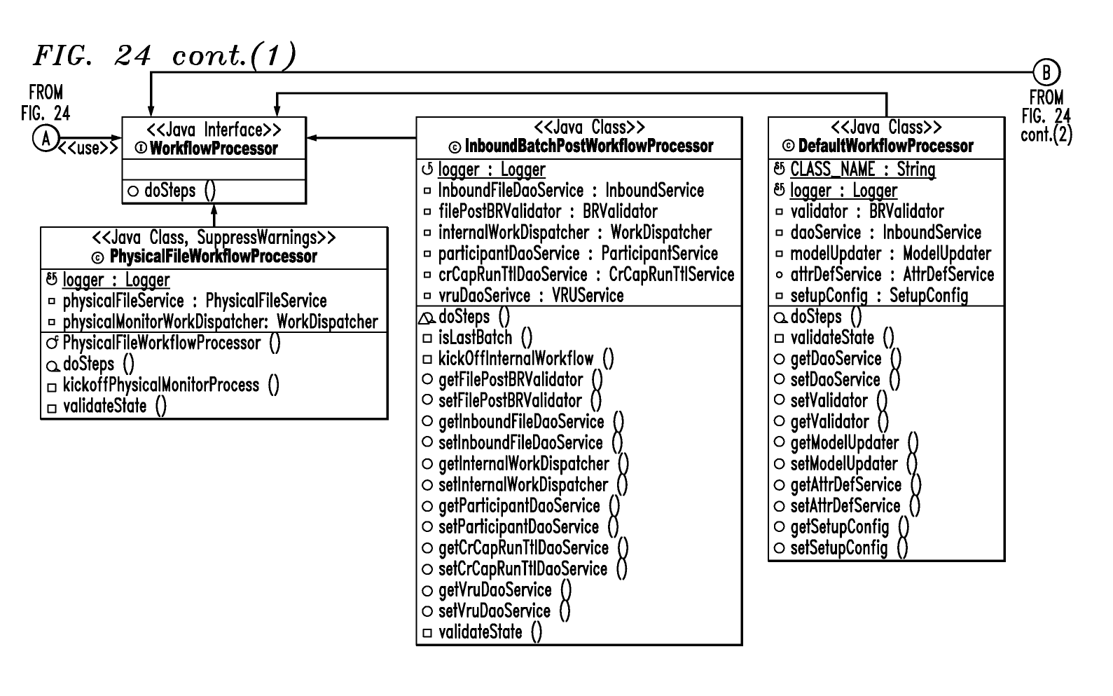

FIG. 23 presents a high level flow diagram for an exemplary stop file work stream 2300. During enrollment 2202, the concentrators and/or biller will provide the information to product support 2206 to register and/or enroll a biller for the service and this will be done in the parameter maintenance 2208. In bock 2210, the biller changes the concentrator; in this process, if the biller and/or concentrator or the start date changes, then the existing relationship should be inactivated and a new one should be set up. During the SOD process 930, for all stop file registrations that have a start date of today, set the registration to active and for all stop file registrations that have an end date of today, set the registration to inactive. During the Inbounding stop account files block 2312, the details of stop account files will be validated and uploaded in the data base 508. During payment processing 2214, apply additional business rules to the standard payment transaction to identify the concentrator and/or biller registered for stop file service. During the SBF process 2218, monthly fee, account upload fee and stop file transaction fee are maintained in bill payment at biller enrollment level.

RPPS has the capability to allow billers and concentrators the option of receiving a file and/or settlement through the automated clearing house (ACH). This allows prompt settlement without the high cost of a “fedwire.” RPPS supports two ACH settlement models. ACH settlement for billers is achieved for processors that do not want to participate in settlement but do process the posting file. ACH settlement can also be achieved for participants that want to receive their posting data and settlement transaction through the ACH.

Non-limiting exemplary details will now be provided regarding a design solution, including system design details. In the non-limiting example, a presentation layer is not employed, nor is an infrastructure layer; other embodiments might employ one or both of these layers.

With regard to process architecture, in some instances, the bill payment application is built based on Java 5 technology and will run on UNIX on suitable high-end servers. The system will is designed to run in a standalone JAVA virtual machine (JVM), within the JAVA 5 runtime environment. The following components and APIs (application program interfaces) are chosen for use in development; others could be used in other cases:

| Name | Version | Description | Reference |
|---|---|---|---|
| JDK/JRE | 1.5 | Java Development Kit | (Refer to Oracle |
| | | API and Java Runtime | Corporation web |
| | | Environment | site) |
| MQ Series | 7.0 | Messaging provider | |
| Spring | 2.5.3 | Application framework | (Refer to Spring |
| | | | Source Community |
| | | | web site) |
| Hibernate | 3.2.6 | ORM framework | (Refer to JBoss |
| | | | community web |
| | | | site) |
| JUnit | 4.4- | Unit Testing Framework | (Refer to Junit |
| | Approved | | web site) |
| | 3.8.1 | | |
| Subversion | 1.4.3 | Version Control system | |
| RAD/RSA | 7 | Rational Application | |
| | | Developer/Rational | |
| | | Software Architect | |
| Ant | 1.7.1 | | (Refer to the |
| | | | Apache Ant |
| | | | project web |
| | | | site) |
| Log4j | 1.2.12 | Logging framework | |
| JBossTS | 4.2.3 | JBossTS is JTA trans- | (Refer to JBoss |
| | | action management func- | community web |
| | | tionality that is used | site) |
| | | by JBoss application | |
| | | server. It can also be | |
| | | embedded into J2SE | |
| | | applications that do | |
| | | not have benefit of a | |
| | | built-in transaction | |
| | | server. | |
| Castor | 1.2 | Castor is a java-xml | (Refer to the |
| | | binding framework. It | Castor project |
| | | provides a quick and | web site) |
| | | easy method for popu- | |
| | | lating Java objects | |
| | | from xml data, or the | |
| | | reverse. | |

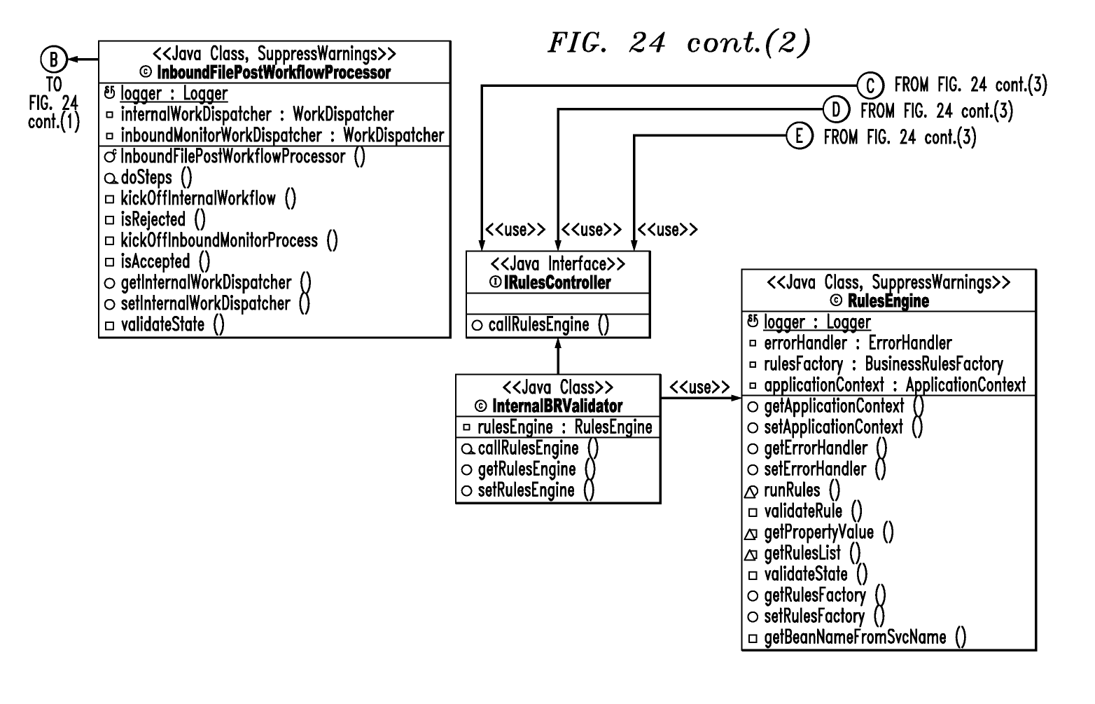

With reference to FIG. 24, one or more embodiments are provided with a business layer having components that focus on processing business data. As seen therein, a number of JAVA classes and JAVA interfaces can be employed in one or more embodiments.

In one or more embodiments, the Data Access layer, in the bill payment system, uses ORM (object relational mapping) technologies such as Hibernate (a powerful, high performance object/relational persistence and query service) for most of the CRUD (CReate, Update, Delete) operations. In certain situations, the IBatis data mapper can be used to run bulk queries. The DAO (Data Access Object) layer uses queries from the ORM framework as well as native SQLs, where appropriate (SQL=Structured Query Language). There are also several stored procedures called from the Java Program and Shell scripts. In some cases, a mixture of both Hibernate and IBatis is used to obtain good performance.

Exemplary details will now be provided regarding an exemplary implementation using JAVA, it being understood that languages other than JAVA, or different approaches using JAVA, could be employed in some instances.

FIG. 24 is a class diagram showing the entities participating in inbound processing and their relationships.

The following is an exemplary JAVA namespace that can be used as the package root for classes in the bill payment application:
com.acme.billpay

The following is an exemplary JAVA namespace that can be used for the classes specific to inbound daemon process:
com.acme.billpay.inbound

The following is an exemplary JAVA namespace that can be used for the classes specific to confirmation queuing process:
com.acme.billpay.confirmation

The following is an exemplary JAVA namespace that can be used for the classes specific to remittance queuing process:
com.acme.billpay.remittance

In a non-limiting example, the following class represents a generic class that can be used to start up the bill payment processes, such as the inbound daemon process, outbound daemon process, confirmation queuing process, remittance queuing process, immediate schedule process, reporting process, and the like:
com.acme.billpay.daemon.BillpayDaemonProcess

In a non-limiting example, it loads the spring bean factory using the SingletonBeanFactoryLocator class which will look for file “beanReffactory.xml” in the root of the classpath. It also initializes all the start-up application components that need to be initialized during the daemon process start up.

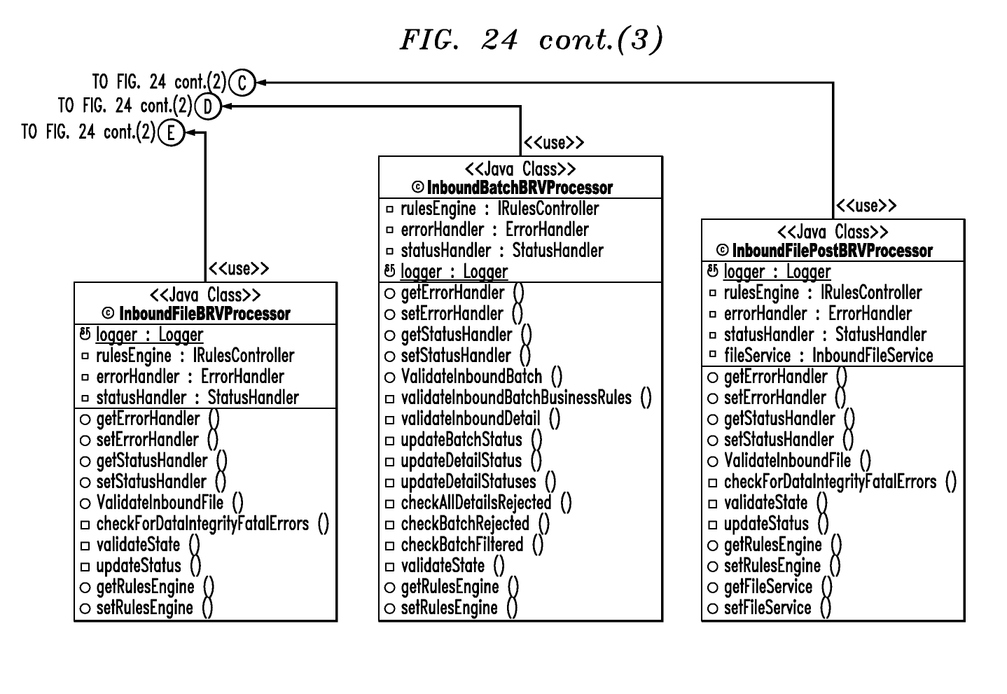

Reference should be had to the following table and to FIG. 25

| Project Name | Description |
|---|---|
| bpCommon 2502 | Contains all the common classes shared across |
| | all other projects |
| bpDomain 2504 | Contains classes related to the persistence layer |
| bpInboundDaemon | Contains classes related to inbound daemon |
| 2506 | process |
| bpRemittanceQueuing | Contains all classes related to the remittance |
| 2508 | queuing process |
| bpConfirmationQueuing | Contains all of the classes related to the |
| 2510 | confirmation queuing process. |
| bpReporting 2512 | Contains all of the classes related to the |
| | reporting queuing process |
| bpImmediateScheduler | Contains all of the classes related to the |
| | immediate schedule queuing process. |
| bpWork 2514 | Contains all classes related to internal work |
| bpSchedulerDaemon | Contains all of the classes related to the |
| | Scheduler Daemon process |
| bpScheduleWork | Contains all the classes related to the SOD |
| | (start of the day) process |

Bill payment preferably has embedded scheduling functionality (bpScheduler) for processing and outbounding customer data. A customer can opt to receive his or her transactions immediately (bpImmediateScheduler) upon arrival. This scheduler is a long running process (bpSchedulerDaemon, bpScheduleWork) that keeps probing for any transactions in the outbound queues ready to be transmitted to the customer.

One or more embodiments include a bill payment monitor component, part of bpInboundDaemon, which may include, for example, threads running continuously; sleeping and waking up at intervals and executing business criteria. Once the business criterion is met they perform any post execution tasks and die.

One or more embodiments include a bill payment Work Dispatcher 791. This component's main responsibility is to dispatch the internal work objects to several internal destination queues as specified in the configuration. For example, when an inbound process 650 has validated its inbound data, it generates an internal work message to be put in the internal process queues. Another responsibility of this component is to build the internal work objects based on the workflow configuration (specified as a map of key value pairs (queuename and InternalWorkType); a configurable value via spring configuration. Values should match with the “enum” constants as defined in the InterWorkType class; that is to say, valid values should be verified against the predefined list of valid values.

One or more embodiments include a bill payment scheduler component, bpScheduler 2516, wherein all scheduler processes are dependent upon parameter maintenance being performed for the scheduling setup information.

One or more embodiments include a bill payment confirmation component (see, e.g., block 1200); a bill payment remittance component (see, e.g., block 10); and/or a bill payment outbound files generation component (see, e.g., block 14).

In one or more embodiments, some utility classes are defined, such as, for example:

com.acme.billpay.util.CommonUtils

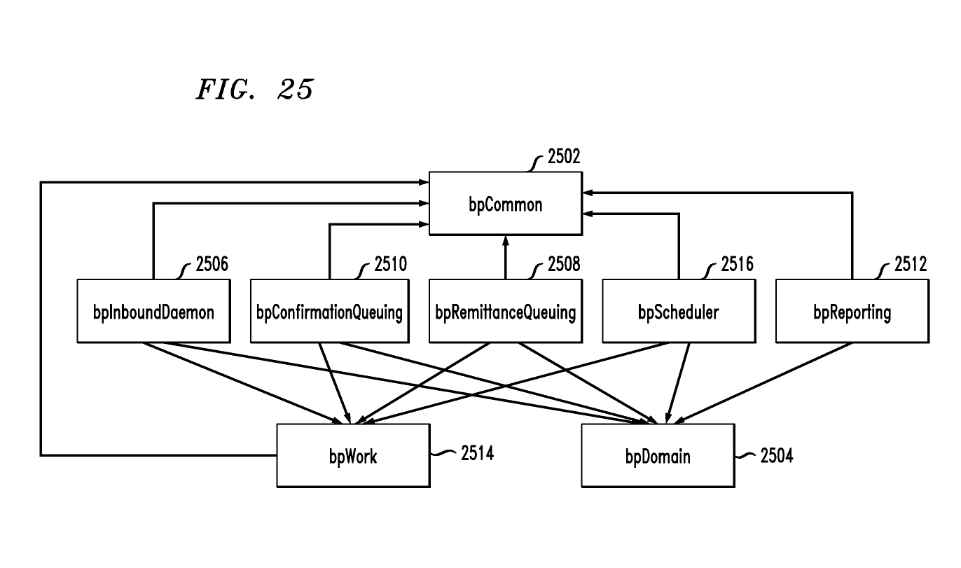

See also FIG. 26.

In some instances, the above utility methods can be used to verify null validity of the method arguments, where appropriate.

One or more embodiments include exception handling capability wherein there is capability for defining a custom exception and/or any new internal error codes.

One or more embodiments employ the well-known log4j tool for logging. In some instances, whenever an error is logged, bill payment will record some standard information for any log:

Error message
Work ID, file ID, Batch ID (as applicable)
Stack trace

In some instances, the bill payment process, before putting a message into a local error queue, will log the error message with the logging level of FATAL. These messages with log level set as FATAL will be monitored using TIVOLI service manager software or the like and a notification will be sent to the support staff.

In a non-limiting example, the following logging levels/priority are chosen while logging to the application log:

| Priority/Level | Usage |
|---|---|
| Debug | Used to communicate details that describe a status |
| | or activity within the code at a specific point in |
| | time, typically used in diagnosing why an error is |
| | occurring |
| Info | Used to communicate messages that would be beneficial |
| | in determine the user and the intent of their request, |
| | typically used in initial diagnostics of errors and |
| | for audit purposes |
| Warn | Used to communicate unexpected situations within |
| | the application that do not result in an exception, |
| | such as re-establishing a connection that is normally |
| | available. |
| Error | Used to communicate instances of exceptions that have |
| | occurred |
| Fatal | Used to communicate instances of exceptions that have |
| | occurred as part of startup and will prevent the |
| | application from being able to process requests in the |
| | future |

The following clarifications are provided re certain terminology employed herein:
NONFINANCIAL PAYMENTS—these allow both the originator (for example, in RPPS or the like) and the concentrator and/or biller to exchange nonpayment transaction information that may require action on the receiving side, such as an account number change.
REVERSALS—these allow originators (for example, in RPPS or the like) to reverse any payment transactions that were sent to concentrators and/or billers erroneously, such as duplicate payment submitted by the consumers, duplicate file being sent by the originator, and the like. This includes, in some instances, handling the Debit cap processing.
RETURNS and RETURN REVERSALS—Allow concentrator and/or biller (for example, in RPPS or the like) to return any payment transactions or reversal transactions to the originators due to an “un-postable” situation on the biller's side. This may be due to the account number being closed, incorrect, or the like. This includes, in some instances, handling returns from the Payment Center via addenda records.
CONVERTING PAYMENTS FOR PORTFOLIO CONVERSION ENROLLMENT—Applies a Product Feature to the standard payment transaction to identify the Concentrator and/or Biller registered for Portfolio conversion and change the Remit biller and Account number for the processing.
STOPPING PAYMENT FOR THE STOP FILE ACCOUNT—Applies additional business rules to the standard payment transaction to identify the Concentrator and/or Biller registered for Stop File service.

One or more embodiments provide a system and/or method for use by an operator of a payment processing network, wherein such operator interconnects a plurality of customer service providers (such as banks of consumers) with a plurality of biller service providers (such as banks of billers). The system processes on-line bill payment transactions. Consumers utilize a service, such as a web site, made available by one of the customer service providers, to specify payment of one or more bills (e.g., electric, phone, gas). Optionally, presentment functionality is provided wherein bills from the billers are presented to the consumers electronically, such as on-line. Reference is made to co-assigned US Patent Publication 2011/0251952 of Kelly et al., entitled “APPARATUS AND METHOD FOR BILL PRESENTMENT AND PAYMENT,” the complete disclosure of which is expressly incorporated herein by reference in its entirety for all purposes. These transactions are routed to the bill payment system according to one or more embodiments of the invention, which helps clear, settle, and move funds from the consumer to the biller. Clearing is a function of processing transactions from the sender and transmitting them to the receiver. The receiver uses this information to reconcile consumer accounts. Settlement is the act of deriving and releasing financial information, from the transactions, to the appropriate financial networks to effect moving funds between the payee and the payor. In one or more embodiments, the front end (online application for consumers to specify payments) is provided by the customer service provider bank and the bank batches the transactions to RPPS or bill payment systems at regular times throughout the day (in RPPS, five pre-defined clearing and settlement times).

One or more embodiments of a bill payment system allow sending files, transactions, or batches all through the day and for processing them at any time of day. In some instances, an entity such as an operator of a payment processing network will process a batch as soon as received; depending on how the receiver has chosen the frequency at which they wish to receive, such entity will forward to them. In essence, one or more embodiments move from first-n-first-out (FIFO) to customer-based processing wherein the originator can define when to process and the receiver can define when to receive. Options include processing at a specified time, specifying whether to process immediately, and/or specifying a window for processing. Unlike the file-based RPPS approach, one or more embodiments of a bill payment system can process in near real time. Some embodiments even afford real-time clearing (but not necessarily settlement) of individual transactions. Such clearing of individual transactions may be effectuated, for example, by interfacing the bill payment system to web services.

In another aspect, each sender and receiver can have their own format; an up-front component translates incoming data into an internal format and switches it back upon dispatch. This is called UMT or Universal Message Translator, as defined earlier.

In a further aspect, business rules may be specified in a file accessed by a business rules engine so as to externalize the rules from the code.

An overall system may include additional servers, clients, or other computers of other entities, interconnected by one or more networks as discussed herein.

Given the discussion thus far, it will be appreciated that, in general terms, an exemplary method, according to an aspect of the invention, includes the step of obtaining, by an operator of a payment processing network, from a plurality of customer service providers (e.g., external members 502), a first plurality of messages. In general, messages can be of many types, such as, for example, payment transactions, returns, reversals, bill presentments, and the like. In the exemplary method, the first plurality of messages specify a plurality of bill payments to a plurality of biller entities. As used herein, “biller entities” is defined to include billers, biller service providers, and/or concentrators. In some instances, this step is carried out by messaging component 522 and inbound daemon processor 650. The first plurality of messages specify, for each of the bill payments, an amount and an intended one of the biller entities to be paid.

Another step includes, based on the first plurality of messages, dispatching, by the operator of the payment processing network, to the plurality of biller entities, a second plurality of messages to initiate the plurality of bill payments. In some instances, this step is carried out by outbound organizer processor 660 and outbound generator processor 662.

Still another step includes obtaining, by the operator of the payment processing network, at least one of:
first data, from at least one of the plurality of customer service providers, specifying when at least some of the first plurality of messages specifying the plurality of bill payments to the plurality of biller entities are to be obtained by the operator of the payment processing network; and
second data, from at least one of the plurality of biller entities, specifying when at least some of the second plurality of messages to initiate the plurality of bill payments are to be dispatched.

In at least some instances, the first data specifies when the instructions are to be obtained from the particular customer service provider (CSP) in question, and the second data specifies when the messages are to be dispatched to the particular biller entity in question. In some instances, the first and second data is stored in bill payment relational database 508 and retrieved as necessary.

The operator of the payment processing network carries out at least one of:
scheduling the step of obtaining the first plurality of messages specifying the plurality of bill payments to the plurality of biller entities in accordance with the first data; and
scheduling the step of dispatching the second plurality of messages in accordance with the second data.

In the context of the above two bullet points, “in accordance with” is defined to cover cases where there are instructions for scheduling all or only some of the pertinent messages. Scheduling the step of obtaining the first plurality of messages may be carried out, for example, using functionality embedded in bill payment inbound preprocessor 504. Scheduling the step of dispatching the second plurality of messages may be carried out, for example, using scheduler daemon processor 658.

In some cases, the second data obtained by the operator of the payment processing network specifies at least one of: immediate dispatch; periodic dispatch; and dispatch at at least one specific time.

In some embodiments, at least some of the second plurality of messages to initiate the plurality of bill payments initiate real time clearing of individual transactions.

In some instances, at least one of:
the scheduling of the step of obtaining the first plurality of messages specifying the plurality of bill payments to the plurality of biller entities in accordance with the first data, and
the scheduling of the step of dispatching the second plurality of messages in accordance with the second data,

is carried out in accordance with a periodic schedule, and a further step includes periodically generating the periodic schedule. Optionally, in the generating step, the periodic schedule is a daily schedule.

In some cases, at least some messages of the first plurality of messages obtained by the operator of the payment processing network are obtained between instances of the periodic schedule generation, and the second data specifies immediate dispatch as to at least some instructions of the second plurality of instructions, and a further step includes updating the periodic schedule between the instances of the periodic schedule generation to reflect the second data specifying the immediate dispatch.

In some embodiments, the scheduling of the step of dispatching the second plurality of messages in accordance with the second data is carried out in accordance with the periodic schedule by having a schedule daemon wake at intervals to check the periodic schedule so as to determine whether start times associated with given ones of the messages have been reached.

In some instances, in the step of obtaining the first plurality of messages, the first plurality of messages further specify, for each of the bill payments, a corresponding payor. In some cases, a batch of messages could be sent with just the amount and the biller, and all messages in the batch are from the same payor.

As is also discussed elsewhere herein, some embodiments further include the additional step of providing a system, wherein the system comprises distinct software modules. Each of the distinct software modules is embodied, in a non-transitory manner, on a computer-readable storage medium. The distinct software modules include a messaging module 522, an inbound daemon processor module 650, an outbound organizer processor module 660, outbound generator processor module 662, a bill payment relational database module 508; a bill payment inbound preprocessor module 504; and a scheduler daemon processor module 658.

In such cases, the step of obtaining the first plurality of messages is carried out by the messaging module 522 and the inbound daemon processor module 650 executing on at least one hardware processor; and the step of dispatching the second plurality of messages is carried out by the outbound organizer processor module 660 and the outbound generator processor module 662 executing on the at least one hardware processor. Furthermore, in the step of obtaining, by the operator of the payment processing network, the at least one of the first data and the second data, the at least one of first data and second data is retrieved from the bill payment relational database module 508. Yet further, the carrying out of the at least one of scheduling the step of obtaining the first plurality of messages and scheduling the step of dispatching the second plurality of messages is carried out by at least a respective one of the bill payment inbound preprocessor module 504 and the scheduler daemon processor module 658, executing on the at least one hardware processor.

In another aspect, one or more embodiments of the invention or elements thereof can be implemented in the form of a system (or apparatus) including a memory and at least one processor that is coupled to the memory and operative to perform method steps as described. In some cases, the at least one processor is operative to perform the steps when instructions, tangibly stored in a non-transitory manner on a computer readable storage medium, are loaded into the memory for execution by the at least one processor.

In still another aspect, an article of manufacture includes a computer program product, and the computer program product in turn includes a tangible computer-readable recordable storage medium, storing in a non-transitory manner computer readable program code. The computer readable program code includes computer readable program code configured to carry out or otherwise facilitate any one, some, or all of the method steps herein.

### System and Article of Manufacture Details

Embodiments of the invention can employ hardware and/or hardware and software aspects. Software includes but is not limited to firmware, resident software, microcode, etc. Software might be employed, for example, in connection with one or more of a terminal 122, 124, 125, 126; a reader 132; payment devices such as cards 102, 112; a host, server, and/or processing center 140, 142, 144 (optionally with data warehouse 154) of a merchant, issuer, acquirer, processor, concentrator, payment network operator, originator, or any other entity as depicted in the figures; and the like; purely by way of further example and not limitation, the elements in FIGS. 5 and 6 can be implemented by suitable software modules. Firmware might be employed, for example, in connection with payment devices such as cards 102, 112 and reader 132. Firmware provides a number of basic functions (e.g., display, print, accept keystrokes) that in themselves do not provide the final end-use application, but rather are building blocks; software links the building blocks together to deliver a usable solution.

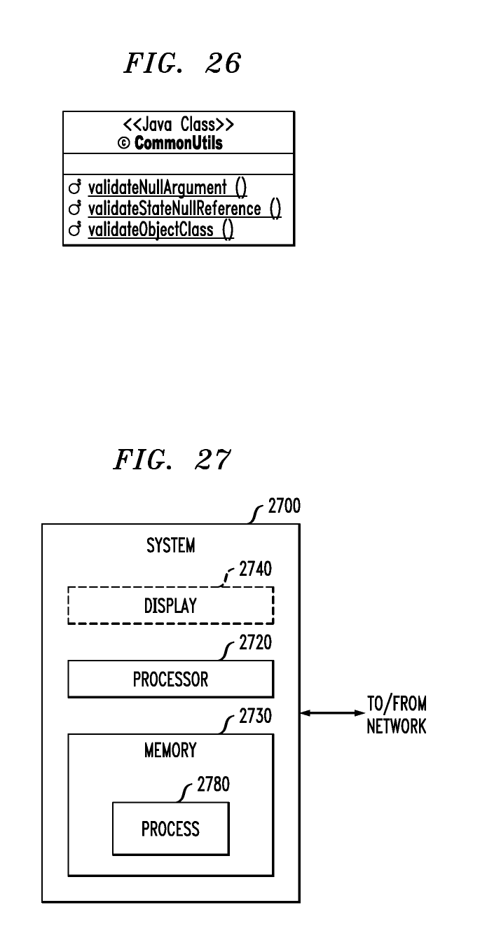

FIG. 27 is a block diagram of a system 2700 that can implement part or all of one or more aspects or processes of the invention. As shown in FIG. 27, memory 2730 configures the processor 2720 (which could correspond, e.g., to processors of hosts and/or servers implementing various functionality, processors of remote hosts in centers 140, 142, 144, or processors associated with any entities as depicted in the figures, and the like) to implement one or more aspects of the methods, steps, and functions disclosed herein (collectively, shown as process 2780 in FIG. 27). Different method steps can be performed by different processors. The memory 2730 could be distributed or local and the processor 2720 could be distributed or singular. The memory 2730 could be implemented as an electrical, magnetic or optical memory, or any combination of these or other types of storage devices. It should be noted that if distributed processors are employed, each distributed processor that makes up processor 2720 generally contains its own addressable memory space. It should also be noted that some or all of computer system 2700 can be incorporated into an application-specific or general-use integrated circuit. For example, one or more method steps could be implemented in hardware in an ASIC rather than using firmware. Display 2740 is representative of a variety of possible input/output devices (e.g., displays, mice, keyboards, and the like).

The notation “to/from network” is indicative of a variety of possible network interface devices.

As is known in the art, part or all of one or more aspects of the methods and apparatus discussed herein may be distributed as an article of manufacture that itself comprises a tangible computer readable recordable storage medium having computer readable code means embodied thereon. The computer readable program code means is operable, in conjunction with a computer system, to carry out all or some of the steps to perform the methods or create the apparatuses discussed herein. A computer-usable medium may, in general, be a recordable medium (e.g., floppy disks, hard drives, compact disks, EEPROMs, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk. The medium can be distributed on multiple physical devices (or over multiple networks). For example, one device could be a physical memory media associated with a terminal and another device could be a physical memory media associated with a processing center. As used herein, a tangible computer-readable recordable storage medium is intended to encompass a recordable medium, examples of which are set forth above, but is not intended to encompass a transmission medium or disembodied signal.

The computer systems and servers described herein each contain a memory that will configure associated processors to implement the methods, steps, and functions disclosed herein. Such methods, steps, and functions can be carried out, e.g., by processing capability on the various elements, platforms, and so on, processors associated with any entities as depicted in the figures, and the like, or by any combination of the foregoing. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

Thus, elements of one or more embodiments of the invention, such as, for example, processors associated with any entities as depicted in the figures; and the like, can make use of computer technology with appropriate instructions to implement method steps described herein. Some aspects can be implemented, for example, using one or more servers which include a memory and at least one processor coupled to the memory. The memory could load appropriate software. The processor can be operative to perform one or more method steps described herein or otherwise facilitate their performance.

Accordingly, it will be appreciated that one or more embodiments of the invention can include a computer program comprising computer program code means adapted to perform one or all of the steps of any methods or claims set forth herein when such program is run on a computer, and that such program may be embodied on a computer readable storage medium. Further, one or more embodiments of the invention can include a computer comprising code adapted to cause the computer to carry out one or more steps of methods or claims set forth herein, together with one or more apparatus elements or features as depicted and described herein.

As used herein, including the claims, a “server” includes a physical data processing system (for example, system 2700 as shown in FIG. 27) running a server program. It will be understood that such a physical server may or may not include a display, keyboard, or other input/output components. A “host” includes a physical data processing system (for example, system 2700 as shown in FIG. 27) running an appropriate program.

Furthermore, it should be noted that any of the methods described herein can include an additional step of providing a system comprising distinct software modules embodied on one or more tangible computer readable storage media. All the modules (or any subset thereof) can be on the same medium, or each can be on a different medium, for example. The modules can include any or all of the components shown in the figures (e.g., servers, engines, hosts, queues, databases, and so on). The method steps can then be carried out using the distinct software modules of the system, as described above, executing on the one or more hardware processors. Further, a computer program product can include a tangible computer-readable recordable storage medium with code adapted to be executed to carry out one or more method steps described herein, including the provision of the system with the distinct software modules.

Thus, aspects of the invention can be implemented, for example, by one or more appropriately programmed general purpose computers, such as, for example, servers or personal computers, located at one or more of the entities in the figures, as well as within the payment network. Such computers can be interconnected, for example, by one or more of a payment processing network, another VPN, the Internet, a local area and/or wide area network (LAN and/or WAN), via an EDI layer, and so on. The computers can be programmed, for example, in compiled, interpreted, object-oriented, assembly, and/or machine languages, for example, one or more of C, C++, Java, Visual Basic, and the like (an exemplary and non-limiting list), and can also make use of, for example, Extensible Markup Language (XML), known application programs such as relational database applications, spreadsheets, and the like. The computers can be programmed to implement the logic and/or data flow depicted in the figures. The following table lists presently preferred, but non-limiting, software useful in one or more embodiments.

| Name | Version | Description |
|---|---|---|
| JDK/JRE | 1.6 | Java Development Kit API |
| | | and Java Runtime |
| | | Environment |
| MQ Series | 7.0 | Messaging provider |
| Spring | 2.5.3 | Application framework |
| Hibernate | 3.2.6 | ORM framework |
| JUnit | 4.4- | Unit Testing Framework |
| | Approved | |
| | 3.8.1 | |
| Subversion | 1.4.3 | Version Control system |
| RAD/RSA | 7 | Rational Application |
| | | Developer/Rational Software |
| | | Architect |
| Ant | 1.7.1 | Apache Ant is a Java library |
| | | and command-line tool |
| | | whose mission is to drive |
| | | processes described in build |
| | | files as targets and extension |
| | | points dependent upon each |
| | | other. |
| Log4j | 1.2.12 | Logging framework |
| JBossTS | 4.2.3 | JBossTS is JTA transaction |
| | | management functionality |
| | | that is used by JBoss |
| | | application server. It can also |
| | | be embedded into J2SE |
| | | applications that do not have |
| | | benefit of a built-in |
| | | transaction server. |
| Castor | 1.2 | Castor is a java-xml binding |
| | | framework. It provides a |
| | | quick and easy method for |
| | | populating Java objects from |
| | | xml data, or the reverse. |

Although illustrative embodiments of the invention have been described herein with reference to the accompanying drawings, it is to be understood that the invention is not limited to those precise embodiments, and that various other changes and modifications may be made by one skilled in the art without departing from the scope or spirit of the invention. For example, items listed as mandatory in some exemplary embodiments may be optional in others, and vice versa.

We claim:

1. A method comprising the steps of:
obtaining, by an operator of a payment processing network, from a plurality of customer service providers, a first plurality of messages specifying a plurality of bill payments to a plurality of biller entities, said first plurality of messages specifying, for each of said bill payments, an amount and an intended one of said biller entities to be paid;
based on said first plurality of messages, dispatching, by said operator of said payment processing network, to said plurality of biller entities, a second plurality of messages to initiate said plurality of bill payments; and
obtaining, by said operator of said payment processing network, at least one of:
first data from at least one of said plurality of customer service providers specifying when at least some of said first plurality of messages specifying said plurality of bill payments to said plurality of biller entities are to be obtained by said operator of said payment processing network; and
second data from at least one of said plurality of biller entities specifying when at least some of said second plurality of messages to initiate said plurality of bill payments are to be dispatched;
wherein said operator of said payment processing network carries out at least one of:
scheduling said step of obtaining said first plurality of messages specifying said plurality of bill payments to said plurality of biller entities in accordance with said first data; and
scheduling said step of dispatching said second plurality of messages in accordance with said second data.

2. The method of claim 1, wherein said second data obtained by said operator of said payment processing network specifies at least one of:
immediate dispatch;
periodic dispatch; and
dispatch at least one specific time.

3. The method of claim 2, wherein at least some of said second plurality of messages to initiate said plurality of bill payments initiate real time clearing of individual transactions.

4. The method of claim 2, wherein:
at least one of:
said scheduling of said step of obtaining said first plurality of messages specifying said plurality of bill payments to said plurality of biller entities in accordance with said first data, and
said scheduling of said step of dispatching said second plurality of messages in accordance with said second data,
is carried out in accordance with a periodic schedule;
further comprising periodically generating said periodic schedule.

5. The method of claim 4, wherein, in said generating step, said periodic schedule comprises a daily schedule.

6. The method of claim 4, wherein at least some messages of said first plurality of messages obtained by said operator of said payment processing network are obtained between instances of said periodic schedule generation and wherein said second data specifies said immediate dispatch as to said at least some instructions of said second plurality of instructions, further comprising updating said periodic schedule between said instances of said periodic schedule generation to reflect said second data specifying said immediate dispatch.

7. The method of claim 4, wherein said scheduling of said step of dispatching said second plurality of messages in accordance with said second data is carried out in accordance with said periodic schedule by having a schedule daemon wake at intervals to check said periodic schedule to determine whether start times associated with given ones of said messages have been reached.

8. The method of claim 1, wherein, in said step of obtaining said first plurality of messages, said first plurality of messages further specify, for each of said bill payments, a corresponding payor.

9. The method of claim 1, further comprising providing a system, wherein the system comprises distinct software modules, each of the distinct software modules being embodied, in a non-transitory manner, on a computer-readable storage medium, and wherein the distinct software modules comprise a messaging module, an inbound daemon processor module, an outbound organizer processor module, outbound generator processor module, a bill payment relational database module; a bill payment inbound preprocessor module; and a scheduler daemon processor;
wherein:
said step of obtaining said first plurality of messages is carried out by said messaging module and said inbound daemon processor module executing on at least one hardware processor;
said step of dispatching said second plurality of messages is carried out by said outbound organizer processor module and said outbound generator processor module executing on said at least one hardware processor;
in said step of obtaining, by said operator of said payment processing network, said at least one of said first data and said second data, said at least one of first data and second data is retrieved from said bill payment relational database module; and
said carrying out of said at least one of scheduling said step of obtaining said first plurality of messages and scheduling said step of dispatching said second plurality of messages is carried out by at least a respective one of said bill payment inbound preprocessor module and said scheduler daemon processor module, executing on said at least one hardware processor.

10. An apparatus comprising:
means for obtaining, by an operator of a payment processing network, from a plurality of customer service providers, a first plurality of messages specifying a plurality of bill payments to a plurality of biller entities, said first plurality of messages specifying, for each of said bill payments, an amount and an intended one of said biller entities to be paid;
means for, based on said first plurality of messages, dispatching, by said operator of said payment processing network, to said plurality of biller entities, a second plurality of messages to initiate said plurality of bill payments;
means for obtaining, by said operator of said payment processing network, at least one of:
first data from at least one of said plurality of customer service providers specifying when at least some of said first plurality of messages specifying said plurality of bill payments to said plurality of biller entities are to be obtained by said operator of said payment processing network; and
second data from at least one of said plurality of biller entities specifying when at least some of said second plurality of messages to initiate said plurality of bill payments are to be dispatched; and
at least one of:
means for said operator of said payment processing network scheduling said step of obtaining said first plurality of messages specifying said plurality of bill payments to said plurality of biller entities in accordance with said first data; and
means for said operator of said payment processing network scheduling said step of dispatching said second plurality of messages in accordance with said second data.

11. An article of manufacture comprising a computer program product, said computer program product comprising:
a tangible computer-readable recordable storage medium, storing in a non-transitory manner computer readable program code, the computer readable program code comprising:
computer readable program code configured to obtain, by an operator of a payment processing network, from a plurality of customer service providers, a first plurality of messages specifying a plurality of bill payments to a plurality of biller entities, said first plurality of messages specifying, for each of said bill payments, an amount and an intended one of said biller entities to be paid;
computer readable program code configured to, based on said first plurality of messages, dispatch, by said operator of said payment processing network, to said plurality of biller entities, a second plurality of messages to initiate said plurality of bill payments;
computer readable program code configured to obtain, by said operator of said payment processing network, at least one of:
first data from at least one of said plurality of customer service providers specifying when at least some of said first plurality of messages specifying said plurality of bill payments to said plurality of biller entities are to be obtained by said operator of said payment processing network; and
second data from at least one of said plurality of biller entities specifying when at least some of said second plurality of messages to initiate said plurality of bill payments are to be dispatched; and
computer readable program code configured to enable said operator of said payment processing network to carry out at least one of:
scheduling said step of obtaining said first plurality of messages specifying said plurality of bill payments to said plurality of biller entities in accordance with said first data; and
scheduling said step of dispatching said second plurality of messages in accordance with said second data.

12. The article of manufacture of claim 11, wherein said second data obtained by said operator of said payment processing network specifies at least one of:
immediate dispatch;
periodic dispatch; and
dispatch at least one specific time.

13. The article of manufacture of claim 12, wherein at least some of said second plurality of messages to initiate said plurality of bill payments initiate real time clearing of individual transactions.

14. The article of manufacture of claim 12, wherein:
at least one of:
said scheduling of said step of obtaining said first plurality of messages specifying said plurality of bill payments to said plurality of biller entities in accordance with said first data, and
said scheduling of said step of dispatching said second plurality of messages in accordance with said second data,
is carried out in accordance with a periodic schedule;
further comprising computer readable program code configured to periodically generate said periodic schedule.

15. The article of manufacture of claim 4, wherein said periodic schedule comprises a daily schedule.

16. The article of manufacture of claim 14, wherein at least some messages of said first plurality of messages obtained by said operator of said payment processing network are obtained between instances of said periodic schedule generation and wherein said second data specifies said immediate dispatch as to said at least some instructions of said second plurality of instructions, further comprising computer readable program code configured to update said periodic schedule between said instances of said periodic schedule generation to reflect said second data specifying said immediate dispatch.

17. The article of manufacture of claim 14, wherein said scheduling of said dispatching of said second plurality of messages in accordance with said second data is carried out in accordance with said periodic schedule by having a schedule daemon wake at intervals to check said periodic schedule to determine whether start times associated with given ones of said messages have been reached, said schedule daemon being implemented by computer readable program code on said tangible computer-readable recordable storage medium.

18. The article of manufacture of claim 11, wherein said first plurality of messages further specify, for each of said bill payments, a corresponding payor.

19. An apparatus comprising:
a memory; and
at least one processor, coupled to said memory, said at least one processor being operative to:
obtain, by an operator of a payment processing network, from a plurality of customer service providers, a first plurality of messages specifying a plurality of bill payments to a plurality of biller entities, said first plurality of messages specifying, for each of said bill payments, an amount and an intended one of said biller entities to be paid;
based on said first plurality of messages, dispatch, by said operator of said payment processing network, to said plurality of biller entities, a second plurality of messages to initiate said plurality of bill payments;
obtain, by said operator of said payment processing network, at least one of:
first data from at least one of said plurality of customer service providers specifying when at least some of said first plurality of messages specifying said plurality of bill payments to said plurality of biller entities are to be obtained by said operator of said payment processing network; and
second data from at least one of said plurality of biller entities specifying when at least some of said second plurality of messages to initiate said plurality of bill payments are to be dispatched; and
enable said operator of said payment processing network to carry out at least one of:
scheduling said step of obtaining said first plurality of messages specifying said plurality of bill payments to said plurality of biller entities in accordance with said first data; and
scheduling said step of dispatching said second plurality of messages in accordance with said second data.

20. The apparatus of claim 19, wherein said second data obtained by said operator of said payment processing network specifies at least one of:
immediate dispatch;
periodic dispatch; and
dispatch at least one specific time.

21. The apparatus of claim 20, wherein at least some of said second plurality of messages to initiate said plurality of bill payments initiate real time clearing of individual transactions.

22. The apparatus of claim 20, wherein:
at least one of:
said scheduling of said step of obtaining said first plurality of messages specifying said plurality of bill payments to said plurality of biller entities in accordance with said first data, and
said scheduling of said step of dispatching said second plurality of messages in accordance with said second data,
is carried out in accordance with a periodic schedule; and
said at least one processor is operative to periodically generate said periodic schedule.

23. The apparatus of claim 22, wherein said periodic schedule comprises a daily schedule.

24. The apparatus of claim 22, wherein at least some messages of said first plurality of messages obtained by said operator of said payment processing network are obtained between instances of said periodic schedule generation and wherein said second data specifies said immediate dispatch as to said at least some instructions of said second plurality of instructions, and wherein said at least one processor is further operative to update said periodic schedule between said instances of said periodic schedule generation to reflect said second data specifying said immediate dispatch.

25. The apparatus of claim 22, further comprising a schedule daemon implemented by instructions executing on said at least one processor, wherein said scheduling of said dispatching of said second plurality of messages in accordance with said second data is carried out in accordance with said periodic schedule by having said schedule daemon wake at intervals to check said periodic schedule to determine whether start times associated with given ones of said messages have been reached.

26. The apparatus of claim 19, wherein said first plurality of messages further specify, for each of said bill payments, a corresponding payor.

27. The apparatus of claim 19, further comprising distinct software modules, each of the distinct software modules being embodied, in a non-transitory manner, on a computer-readable storage medium, and wherein the distinct software modules comprise a messaging module, an inbound daemon processor module, an outbound organizer processor module, outbound generator processor module, a bill payment relational database module; a bill payment inbound preprocessor module; and a scheduler daemon processor;
wherein:
said at least one processor is operative to obtain said first plurality of messages by executing said messaging module and said inbound daemon processor module;
said at least one processor is operative to dispatch said second plurality of messages by executing said outbound organizer processor module and said outbound generator processor module;
when said at least one processor is operative to obtain said at least one of said first data and said second data, said at least one of first data and second data is retrieved from said bill payment relational database module; and
said at least one processor is operative to carry out said at least one of scheduling said step of obtaining said first plurality of messages and scheduling said step of dispatching said second plurality of messages by executing at least a respective one of said bill payment inbound preprocessor module and said scheduler daemon processor module.
